(19) United States
(12) Patent Application Publication
(10) Pub. No.: US 2006/0123207 A1
(43) Pub. Date: Jun. 8, 2006

(54) Disk system having function of virtualizing logical disk in portable storage device

(76) Inventors: Akira Yamamoto, Sagamihara (JP); Fumi Miyazaki, Kawasaki (JP); Masayuki Yamamoto, Sagamihara (JP); Yasunori Kaneda, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/079,236

(22) Filed: Mar. 15, 2005

(30) Foreign Application Priority Data
Dec. 2, 2004 (JP) 2004-349266

(51) Int. Cl. G06F 12/16; G06F 12/00

(52) U.S. Cl. 711/161

(57) ABSTRACT

Long-term preservation of data (archive) has become more important. In order to reduce the maintenance cost for data, a first storage system consolidating a disk system and an MT library system has a disk interface with respect to a host computer and has a function of storing a logical volume in an MT. In addition, the first storage system has a function of managing information such as information indicating in which MT the logical volume is stored, and in which slot of a library the MT is stored. By using such functions, it is possible to integrally manage storage areas of the disk system and the MT library as logical volumes, thereby reducing the management cost.

### CROSS REFERENCE TO RELATED APPLICATIONS

This application relates to, and claims priority from, Japanese Patent Application No. 2004-349266, filed on Dec. 2, 2004, the entire disclosure of which is incorporated herein by reference.

### BACKGROUND OF THE INVENTION

The present invention relates in general to a storage system for storing data; and, more particularly, the present invention relates to a disk system consolidating portable storage devices, such as MT (Magnetic Tapes).

Laws or regulations for preserving data treated by enterprises have been established, and long-term preservation of data (archive) has become more important to these enterprises. On the other hand, the quantities of data treated by such enterprises have drastically increased. In addition, the utility value of accumulated data changes depending upon conditions, such as the lapse of time or the frequency of access. Therefore, for example, when archive data not subject to frequent accesses is successively stored in high-performance storages, a problem arises in that a large bit cost is encountered. In order to solve this problem, a technology is disclosed in Japanese Patent No. 2682811, wherein data is stored in a hierarchy computer system employing, for example, a storage apparatus having a high performance and a large bit cost, and an MT library apparatus having a low performance and a small bit cost.

The total maintenance cost of data in a computer system should include the management cost for the computer system, as well as the bit cost for maintenance of the data. Japanese Patent No. 2682811 discloses technology capable of reducing the bit cost for maintenance of the data. However, with such technology, configuration management of the storage apparatus or the MT library apparatus constituting the computer system, maintenance management of MT media, data management for searching for archive data, etc. need to be carried out individually, thereby increasing the management cost.

### BRIEF DESCRIPTION OF THE DRAWINGS

FIG. 1 is a structural block diagram of a system according to a first embodiment of the present invention.

FIG. 2 is another structural block diagram of the system according to the first embodiment of the present invention.

FIG. 3 is a structural block diagram of an example of the MT library used in accordance with the present invention.

FIGS. 4A and 4B are conceptual diagrams illustrating an example of the method of transferring a logical volume from a disk system to the MT library according to the first embodiment of the present invention.

FIG. 5A is a diagram illustrating an example of the status change corresponding to the process of FIG. 4A, FIG. 5B is a diagram illustrating an example of the status change corresponding to the process of FIG. 4B, and FIG. 5C is a diagram illustrating an example of the status of a logical volume as viewed from a host computer.

FIG. 6 is a diagram illustrating an example of the volume management information.

FIG. 7A is a diagram illustrating an example of media management information, and FIG. 7B is a diagram illustrating an example of MT-drive management information.

FIG. 8 is a process flow diagram illustrating a status change from SMPL to PAIR, as shown in FIG. 5A, according to the first embodiment of the present invention.

FIG. 9 is a diagram illustrating an example of volume management information when the process flow of FIG. 8 is completed.

FIG. 10 is a process flow diagram illustrating a status change from PAIR to PSUS, as shown in FIG. 5A, according to the first embodiment of the present invention.

FIG. 11 is a diagram illustrating an example of volume management information when the process flow of FIG. 10 is completed.

FIG. 12A is a process flow diagram illustrating a status change from PSUS to PAIR, as shown in FIG. 5A, according to the first embodiment of the present invention.

FIG. 12B is a process flow diagram illustrating a status change from PSUS to PAIR, as shown in FIG. 5A, according to the first embodiment of the present invention.

FIG. 13 is a diagram illustrating an example of volume management information when the process flow of FIG. 12 is completed.

FIG. 14 is a process flow diagram illustrating a status change from PAIR to SMPL, as shown in FIG. 5A, according to the first embodiment of the present invention.

FIG. 15 is a diagram illustrating an example of volume management information when the process flow of FIG. 14 is completed.

FIG. 16 is a process flow diagram illustrating a status change from SMPL to UNDER STORE OF TAPE, as shown in FIG. 5B, according to the first embodiment of the present invention.

FIG. 17 is a diagram illustrating an example of volume management information when the process flow of FIG. 16 is completed.

FIG. 18 is a process flow diagram illustrating a status change from UNDER STORE OF TAPE to SMPL, as shown in FIG. 5B, according to the first embodiment of the present invention.

FIG. 19 is a diagram illustrating an example of volume management information when the process flow of FIG. 18 is completed.

FIG. 20 is a structural block diagram of a system according to a second embodiment of the present invention.

FIG. 21A is a structural block diagram of an example of a disk system according to the second embodiment of the present invention, and FIG. 21B is a structural block diagram of an example of a management terminal according to the second embodiment of the present invention.

FIGS. 22A and 22B are conceptual diagrams illustrating an example of a method of transferring a logical volume from an MT library to a shelf of a warehouse according to the second embodiment of the present invention.

FIG. 23A is a diagram illustrating an example of media management information, FIG. 23B is a diagram illustrating an example of slot management information, and FIG. 23C is a diagram illustrating an example of shelf information.

FIG. 24 is a process flow diagram of a process carried out by a processor of the disk system when a specific tape is transferred to a shelf from a slot.

FIG. 25 is a process flow diagram of a process carried out by a maintenance man when the specific tape is transferred to a shelf from a slot.

FIG. 26 is a process flow diagram of a process carried out by the processor of the disk system when the specific tape is transferred to a slot from a shelf.

FIG. 27 is a process flow diagram of a process carried out by a maintenance man when the specific tape is transferred to a slot from a shelf.

FIG. 28 is a process flow diagram illustrating a status change from PSUS to PAIR, as shown in FIG. 5A, according to the second embodiment of the present invention.

FIG. 29 is a process flow diagram illustrating a status change from PAIR to SMPL, as shown in FIG. 5A, according to the second embodiment of the present invention.

FIG. 30 is a process flow diagram illustrating a status change from UNDER STORE OF TAPE to SMPL, as shown in FIG. 5B, according to the second embodiment of the present invention.

### DETAILED DESCRIPTION

Hereinafter, various embodiments of the present invention will be described with reference to the drawings.

### First Embodiment

A first embodiment of the present invention will be described with reference to the drawings.

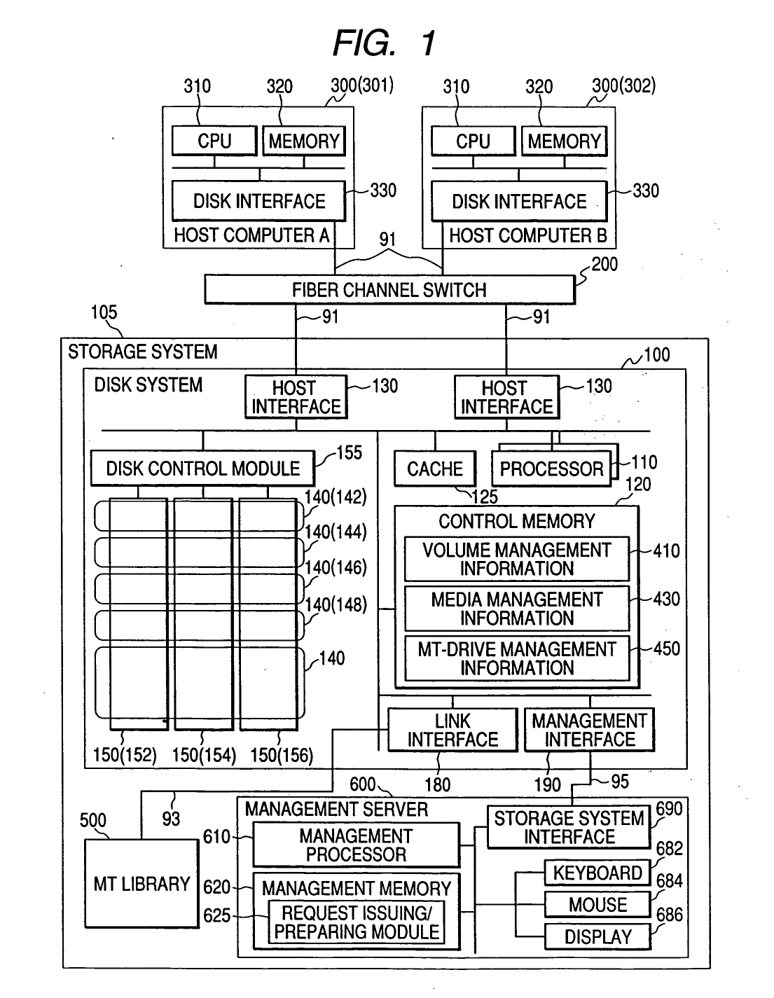

FIG. 1 is a structural block diagram illustrating the first embodiment of the present invention. The first embodiment includes one or more host computers 300, together with a fiber channel switch 200, and a storage system 105. However, in accordance with the present invention, as a device for connecting the host computer 300 to the storage system 105, a connection mechanism other than the fiber channel switch 200, such as an IP switch, a connection mechanism for a main frame, etc., can be effectively used.

The number of host computers 300 connected to the storage system 105 may be one or plural (for example, host computer A 301 and host computer B 302). The host computer 300 may include a CPU 310, a memory 320, and a disk interface 330.

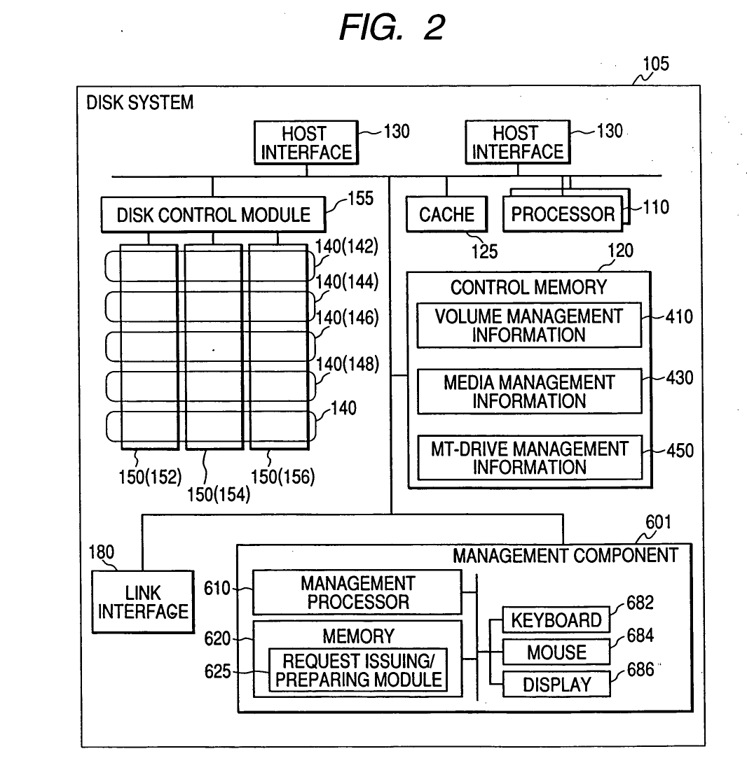

The storage system 105 may include a disk system 100, a management server 600, and an MT library 500. As shown in FIG. 2, an alternative disk system 105 may provide the function of the management server 600 as a management component 601.

The disk system 100 may include one or more host interfaces 130 connected to the fiber channel switch 200, one or more disk devices 150, a disk control module 155 for controlling the disk devices, a cache (memory) 125, one or more processors 110, a control memory 120, a link interface 180, which may interface with an MT library 500, and a management interface 190, which may interface with the management server.

One or more disk devices 150 may be provided (for example, a disk device 152, a disk device 154, and a disk device 156). In the disk system 100, a disk volume (extending across one or more physical disk devices) read or written by the host computer 300 is referred to as a logical volume 140. The logical volume 140 may not correspond to the disk device 150 on a one to one basis, but the contents of one logical volume 140 may be defined in a plurality of disk devices 150. One or more logical volumes 140 may be provided (for example, a logical volume 142, a logical volume 144, a logical volume 146, a logical volume 148, . . . ). By making the logical volume 140 have a RAID structure, loss of the contents of the logical volume 140 may be prevented even when any one physical disk device 150 becomes out of order.

The cache 125 may store a part of data in the logical volume 140. The cache 125 may be non-volatile or duplex (i.e., duplicate or redundant memory having the same contents). The control memory 120 may store the management data of the disk system 100. The control memory 120 may be non-volatile or duplex (i.e., duplicate or redundant memory having the same contents). The control memory 120 may include volume management information 410, media management information 430, and MT-drive management information 450.

The processor 110 may transfer data to a logical volume 140 in response to a read request or a write request from the host computer 300.

Alternatively, the processor may transfer data of a logical volume 140 in response to a request from the management server 600.

The management server 600 may include a management processor 610, a management memory 620, a storage system interface 690, a keyboard 682, a mouse 684, and a display 686. The management memory 620 may store a request issuing/preparation module 625.

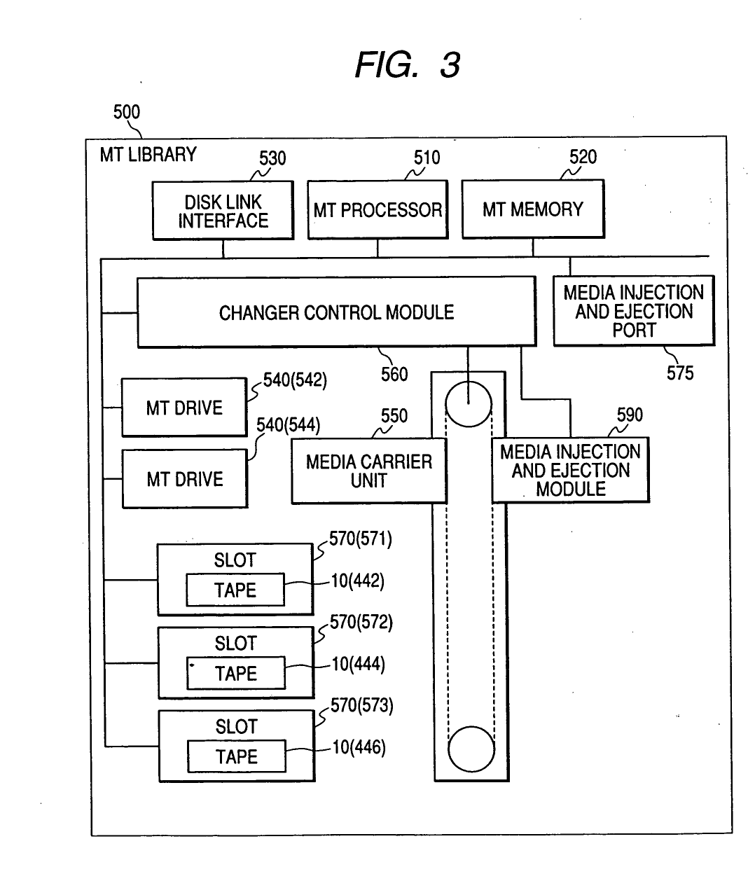

FIG. 3 is a structural block diagram showing an example of the MT library 500 used in the first embodiment. The MT library 500 may include a disk link interface 530 which is a link interface with the disk system 100, an MT processor 510, an MT memory 520, a changer control module 560, one or more MT drives 540 (for example, 542, 544), one or more slots 570 (for example, 571, 572, 573), one or more tapes 10 (for example, 442, 444, 446), a media carrier unit 550, a media injection and ejection port 575, and a media injection and ejection module 590. One or more MT drives 540 and slots 570 may be provided.

The MT processor 510 may carry out the following control in response to requests received from the disk system 100 (including MT drives 542 and 544, slots 571, 572, and 573):

(1) Carry a specified tape 10 between the specified MT drive 540 and the specified slot 570 under control of the changer control module 560 using the media carrier unit 550;

(2) Write data obtained from the disk system 100 to the tape 10 fitted into the specified MT drive 540, or send data of the tape 10 to the disk system 100; and

(3) Carry the tape placed in a specified slot 570 to the media injection and ejection port 575, or carry the tape placed at the media injection and ejection port 575 to the specified slot 570, using the media injection and ejection module 590.

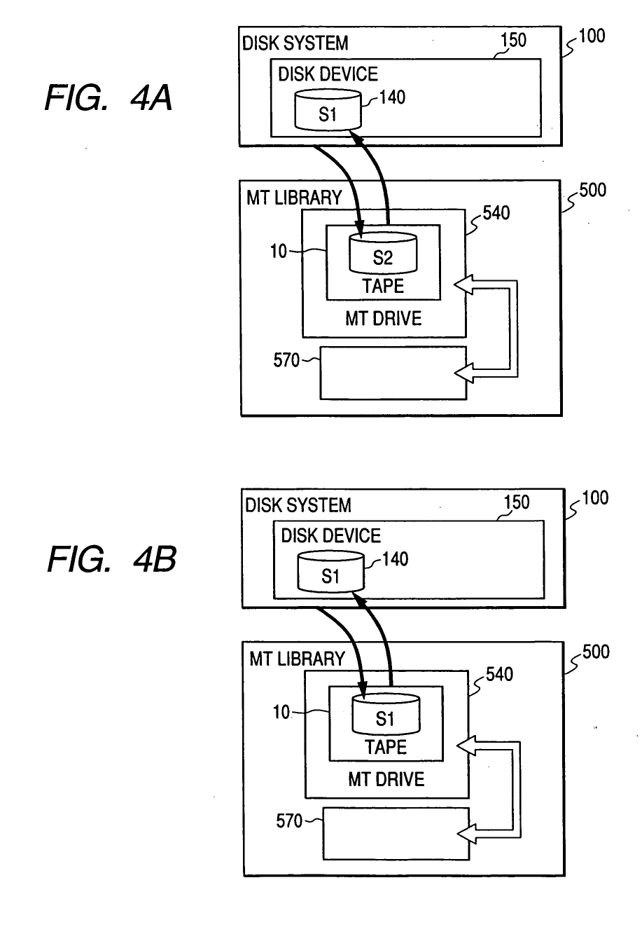

FIGS. 4A and 4B illustrate an example of the basic concepts of the first embodiment of the present invention. It is an object of the present embodiment to reduce the total cost for the storage system by storing the contents of the logical volume 140 stored in the disk device 150 of the disk system 100 to a tape 10. The present embodiment is characterized in that the logical volume 140 stored in the tape 10 may be recognized by the host computer 300, as if the logical volume exists in the disk system 100. In brief, the process of transferring data of the logical volume 140 stored in the disk device 150 to the tape 10 may be carried out by the disk system 100 independently of the host computer 300.

The present embodiment discloses two examples of methods of transferring data. FIG. 4A shows a method of copying the logical volume S1 stored in the disk device 150 to the logical volume S2 allocated to the tape 10. Specifically, the disk system 100 gives an instruction to the MT library 500, so that the MT processor 510 carries the tape 10 for storing the logical volume S2 to the MT drive 540 from the slot 570. Next, the disk system 100 writes the contents of the logical volume S1 to the tape 10 placed in the MT drive 540. After completion of the writing, the MT processor 510 carries the tape 10 to the slot 570 from the MT drive 540 in accordance with the instruction from the disk system 100. In this case, since the contents of the logical volume S1 are stored in the logical volume S2 defined in the tape 10, the processor 110 of the disk system 100 may delete the contents of the logical volume S1 after completion of the copy process, which is advantageous to free up space.

FIG. 4B shows a method of allocating the logical volume S1 stored in the disk device 150 directly to the tape 10. The process executed by the MT library 500 in accordance with the instruction from the disk system 100 is similar to that of FIG. 4A.

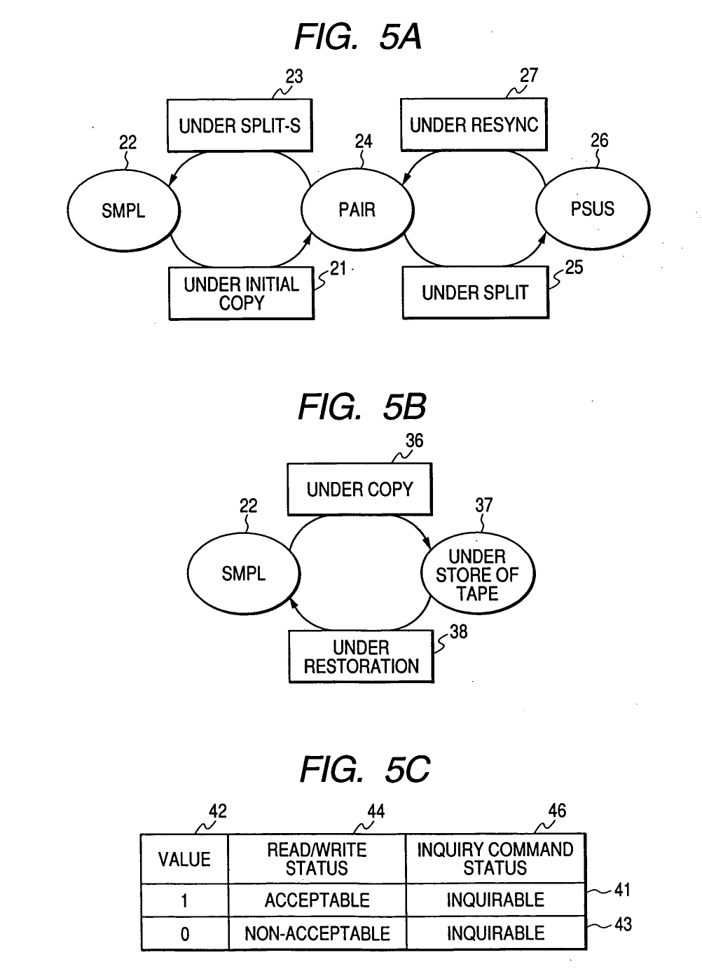

FIG. 5A shows an example of the status change corresponding to the process of FIG. 4A. SMPL 22 indicates a status (Simplex) where the contents of the logical volume 140 (logical volume S1) are defined in the disk device 150. UNDER INITIAL-COPY 21 indicates a status where the logical volume S2 allocated to the tape 10 is defined and data is being copied from the logical volume S1 to the logical volume S2. When the copy process is completed, a pair status of the logical volume S1 and the logical volume S2 becomes a status of PAIR 24. When the pair status of the logical volume S1 and the logical volume S2 is released, the status is restored to SMPL 22 via UNDER SPLIT-S 23. In this case, the logical volume S2 defined in the tape 10 is generally released, but it may be kept as it is. When the logical volume is not released, the logical volume S1 and the logical volume S2 are completely independent of each other.

In the status of PAIR 24, when the logical volume S1 of the disk device 150 is intended to be deleted, the status is changed to PSUS 26 via UNDER SPLIT 25. When the logical volume S1 is defined again in the disk device 150 and the data of the tape 10 is restored, the status returns to PAIR 24 via UNDER RESYNC 27.

FIG. 5B shows an example of the status change corresponding to the process of FIG. 4B. SMPL 22 is similar to that of FIG. 5A. UNDER COPY 36 indicates a status that reserves the area for storing the logical volume 140 in the tape 10 and where data of the disk device 150 is being copied to the tape 10. When the copy process is completed, the status is changed to UNDER STORE OF TAPE 37. At this time, the area for the logical volume 140 allocated to the disk device 150 is released. When the data of the tape 10 is restored to the disk device 150, the status is changed to UNDER RESTORE 38. At this time, the disk system 100 reserves an area for storing the contents of the logical volume 140 in the disk device 150 and copies the data of the tape 10 to the disk device 150. When the copy process is completed, the status returns to SMPL 22. At this time, the area of the tape 10 having stored the data of the logical volume 140 is released.

FIG. 5C is a diagram illustrating an example of the status of the logical volume 140 as viewed from the host computer 300. A status value (“1” or “2”) 42 of READ/WRITE STATUS 44 indicates whether reading and writing of the logical volume 140 by the host computer 300 is permitted (ACCEPTABLE) or inhibited (NON-ACCEPTABLE).

An INQUIRY COMMAND STATUS 46 indicates whether the disk system 100 can inquire as to the presence of an inquiry command or not. As an example, when data of the logical volume 140 is stored in the disk device 150, READ/WRITE STATUS 44 may be acceptable and the INQUIRY COMMAND STATUS 46 may be inquirable. On the other hand, when data of the logical volume 140 is not stored in the disk device 150, but is stored only in the tape 10, the READ/WRITE STATUS 44 may be non-acceptable and the INQUIRY COMMAND STATUS 46 may be inquirable. This is because, when the disk system 100 accepts the read or write request, it is necessary to complete the process in a predetermined time, but the period of time required for carrying the tape 10 stored in the slot 570 to the MT drive 540 is not sufficient.

As a result, when a request for changing the status of the logical volume, where the READ/WRITE_STATUS 44 of which is non-acceptable, to a status, where the READ/WRITE STATUS 44 is acceptable, from the host computer 300 is accepted, it is necessary to allocate an area of the disk device 150 to the logical volume 140 and to store data in the area.

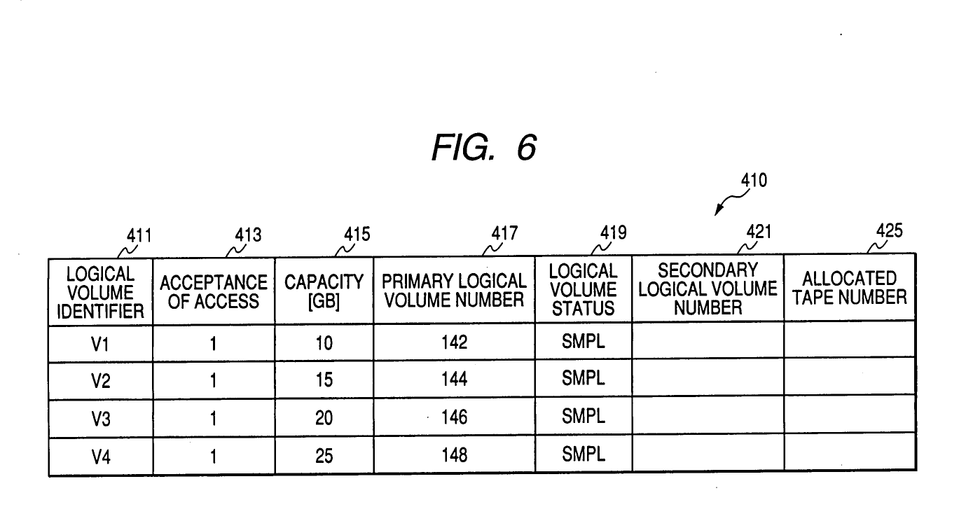

FIG. 6 shows an example of the volume management information 410 stored in the control memory 120 of the disk system 100. A LOGICAL VOLUME IDENTIFIER 411 is an identifier of the corresponding logical volume 140. ACCEPTANCE OF ACCESS 413 is a status where the READ/WRITE STATUS 44 and the INQUIRY COMMAND STATUS 46 are combined. When the ACCEPTANCE OF ACCESS 413 is 1, the READ/WRITE STATUS 44 is acceptable and the INQUIRY COMMAND STATUS 46 is inquirable. On the other hand, when the ACCEPTANCE OF ACCESS 413 is 0, the READ/WRITE STATUS 44 is non-acceptable and the INQUIRY COMMAND STATUS 46 is inquirable. CAPACITY 415 indicates the capacity of the logical volume 140, and the unit thereof is, for example, a GB.

A PRIMARY LOGICAL VOLUME NUMBER 417 denotes the number of a primary logical volume 140. A LOGICAL VOLUME STATUS 419 denotes a status of a corresponding logical volume 140. Here, the LOGICAL VOLUME STATUS 419 changes in accordance with the status change shown in FIG. 5A or 5B. A SECONDARY LOGICAL VOLUME NUMBER 421 denotes a number of an allocated logical volume when a different logical volume 140 is allocated to the tape 10, that is, when the status change shown in FIG. 5A is performed. An ALLOCATED TAPE NUMBER 425 denotes the number of the tape 10 allocated to the corresponding logical volume 140.

In the information shown in FIG. 6, the LOGICAL VOLUME IDENTIFIERS 411 range from V1 to V4, the ACCEPTANCE OF ACCESS 413 are all 1, and the CAPACITY 415 and the PRIMARY LOGICAL VOLUME NUMBER 417 are defined, respectively. Since the LOGICAL VOLUME STATUSES 419 are all SMPL 22, information from the SECONDARY LOGICAL VOLUME NUMBER 421 is not set.

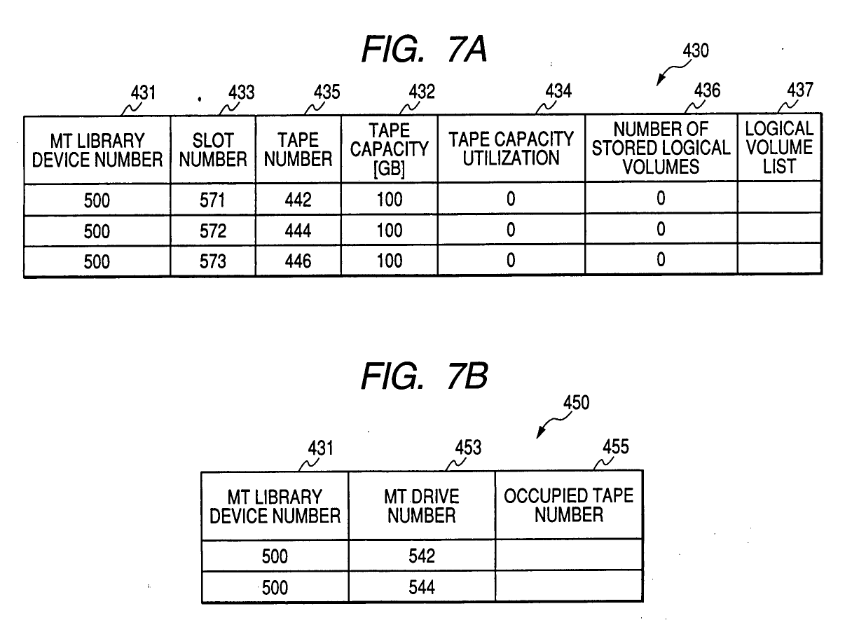

FIGS. 7A and 7B show another example of the information stored in the control memory 120 of the disk system 100.

FIG. 7A shows an example of the media management information 430. The media management information 430 may be provided at each tape 10. In the first embodiment, one slot 570 is necessarily allocated to each tape. An MT LIBRARY DEVICE NUMBER 431 denotes an MT library 500 in which the tape 10 is stored. A SLOT NUMBER 433 is the number of the slot 570 corresponding to the tape 10. A TAPE NUMBER 435 denotes the number of the corresponding tape 10. A TAPE CAPACITY 432 and TAPE CAPACITY UTILIZATION 434 denote the capacity of the corresponding tape and the capacity in which data are actually stored, respectively. The NUMBER OF STORED LOGICAL VOLUMES 436 denotes the number of the logical volumes 140 stored in the corresponding tape 10. A LOGICAL VOLUME LIST 437 is a list of identifiers of the logical volumes stored in the tape.

The value of the PRIMARY LOGICAL VOLUME NUMBER 417 in the case of the status change shown in FIG. 5B and the value of the SECONDARY LOGICAL VOLUME NUMBER 421 in the case of the status change shown in FIG. 5A are arranged so as to be as many as the number shown as the NUMBER OF STORED LOGICAL VOLUMES 436. In the tape 10, the contents of the logical volumes 140 are stored from the front end of the tape 10 in the order registered in the LOGICAL VOLUME LIST 437. Here, an example is shown where the MT LIBRARY DEVICE NUMBER 431, the SLOT NUMBER 433, the TAPE CAPACITY 432, and the TAPE CAPACITY UTILIZATION 434 are set with respect to the tapes 10 having the TAPE NUMBERS 435 of 442, 444, and 446. On the assumption that data of the logical volume 140 is not stored in any tape 10, all of the TAPE CAPACITY UTILIZATIONS 434 are 0.

FIG. 7B shows MT-drive management information 450, which is information provided at each MT drive 540. The MT LIBRARY DEVICE NUMBER 431 denotes the MT library 500 receiving the corresponding MT drive 540, similarly to the information shown in FIG. 7A. The MT DRIVE NUMBER 453 designates a MT drive 540 which a magnetic tape currently occupies. An OCCUPIED TAPE NUMBER 455 is the number of the tape 10 stored in the corresponding MT drive 540. When no tape 10 is stored in the MT drive 540, the OCCUPIED TAPE NUMBER is null. In the example of FIG. 7B, since it is assumed that no tape 10 is stored in any MT drive 540, the values are all set to null.

Now, an example of the process flow according to the first embodiment will be described. The process flow corresponds to the status change shown in FIGS. 5A and 5B. The process flow is carried out by the processor 110 of the disk system 100. The process flow is typically triggered in response to a request from the host system (host computer) 300 or the management server 600. Here, for the purpose of easy understanding, how the volume management information 410 shown in FIG. 6 is changed when the respective status changes are executed will be described.

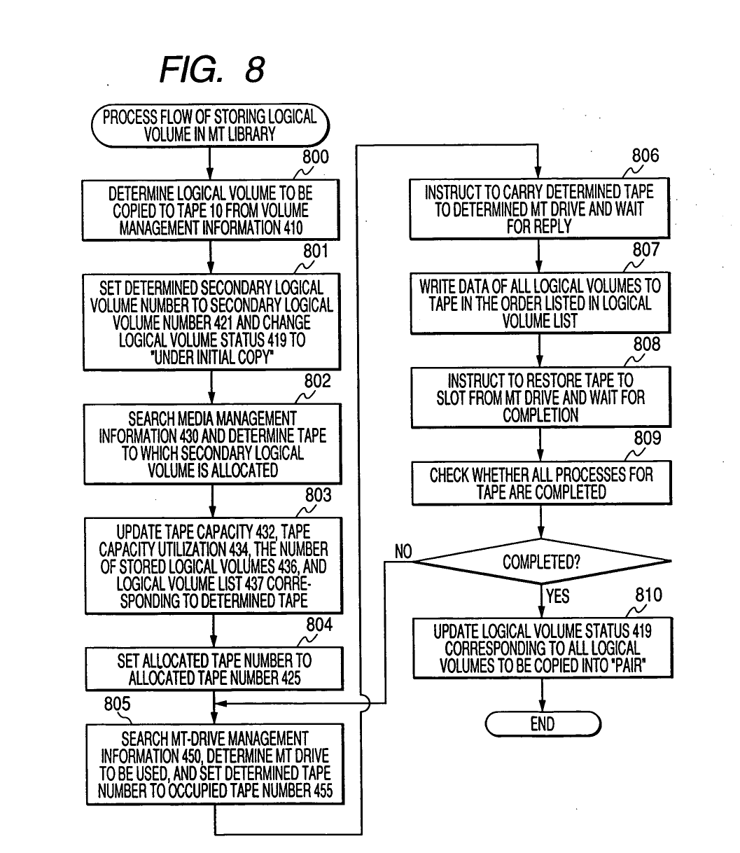

FIG. 8 is an example of the process flow illustrating a status change from SMPL 22 to PAIR 24, as shown in FIG. 5A. Here, it is assumed that the statuses of the logical volumes 140, of which the LOGICAL VOLUME IDENTIFIERS 411 are V1 and V2, respectively, are changed. Further, it is assumed that the tapes 10 to which a new logical volume 140 is allocated have 442 as the TAPE NUMBERS 435.

At step 800, the logical volume 140 to be copied to the tape 10 is recognized. The logical volume 140 to be copied may be specified directly by the host system 300 or the management server 600, or it may be determined by the processor 110 using any method. Here, the logical volumes 140 having the LOGICAL VOLUME IDENTIFIERS 411 of V1 and V2 are to be copied.

At step 801, the SECONDARY LOGICAL VOLUME NUMBERS 421 of the specified logical volumes 140 are determined, and the values are set. The LOGICAL VOLUME STATUS 419 is changed to UNDER INITIAL COPY 21.

At step 802, the tape 10 to which the SECONDARY LOGICAL VOLUME NUMBERS 421 are allocated is determined. The tape to be allocated is determined by searching the media management information 430 and finding a tape 10 that is not in use. Here, since the sum of the CAPACITIES 415 of the logical volumes 140 having the LOGICAL VOLUME IDENTIFIERS 411 of V1 and V2 is smaller than the TAPE CAPACITY 432 of the tape 10 having the TAPE NUMBER of 442, the tape 10 having the TAPE NUMBER of 442 is selected as the tape 10 to which the SECONDARY LOGICAL VOLUME NUMBER field 421 is allocated. Of course, when the sum of the logical volume CAPACITIES 415 to be copied is greater, a plurality of tapes 10 are selected.

At step 803, the sum value of the CAPACITIES 415 of the logical volumes 140 allocated to the selected tape 10 is written to the TAPE CAPACITY UTILIZATIONS field 434 corresponding to the selected tape 10, and the TAPE CAPACITY field 432 is updated. The number of logical volumes 140 to be written to the tape 10 is set to the NUMBER OF STORED LOGICAL VOLUMES field 436 corresponding to the selected tape 10. Finally, a list of the SECONDARY LOGICAL VOLUME NUMBERS 421 corresponding to the logical volumes 140 to be written to the tape 10 is prepared and set to the LOGICAL VOLUME LIST 437 corresponding to the selected tape 10. Here, the sum value of the CAPACITIES 415 of the logical volumes 140 having the LOGICAL VOLUME IDENTIFIERS 411 of V1 and V2 is set to the TAPE CAPACITY 432, 2 is set to the NUMBER OF STORED LOGICAL VOLUMES 436, and the list of the SECONDARY LOGICAL VOLUME NUMBERS 421 having the LOGICAL VOLUME IDENTIFIERS 411 of V1 and V2 is set to the LOGICAL VOLUME LIST 437. Here, the logical volumes are stored in the order of V1 and V2.

At step 804, the TAPE NUMBER 435 of the allocated tape 10 is set to the ALLOCATED TAPE NUMBER 425 of the corresponding logical volumes 140. Here, 442 (442 is the TAPE NUMBER 435) is set to the ALLOCATED TAPE NUMBER 425 having the LOGICAL VOLUME IDENTIFIERS 411 of V1 and V2.

At step 805, one of the tapes 10 recognized at step 802 is selected and the MT drive 540 used for the copy process is determined. By searching the MT-drive management information 450, the MT drive 540 to be used can be determined. Here, the TAPE NUMBER 435 of the selected tape 10 is set to the OCCUPIED TAPE NUMBER 455 of the determined MT drive 540.

At step 806, the MT library 500 is instructed to carry the tape 10 selected at step 805 to the MT drive 540 and a reply is waited for.

Thereafter, at step 807, data of all of the logical volumes 140 allocated to the tape 10 are written to the tape 10. Here, the logical volumes 140 are stored in the tape 10 in the order stored in the LOGICAL VOLUME LIST 437.

At step 808, the MT library 500 is instructed to restore the tape 10 selected at step 805 to the original slot 570 from the MT drive 540, and the completion thereof is waited for.

Thereafter, as step 809, it is checked whether all of the tapes 10 recognized at step 802 are processed completely. When they are not processed completely, a loop beginning at step 805 is performed again.

Thereafter, at step 810, the LOGICAL VOLUME STATUSES 419 corresponding to all of the logical volumes 140 recognized to be copied at step 800 are changed to PAIR 24. Here, the LOGICAL VOLUME STATUSES 419 having the LOGICAL VOLUME IDENTIFIERS 411 of V1 and V2 are changed to PAIR 24.

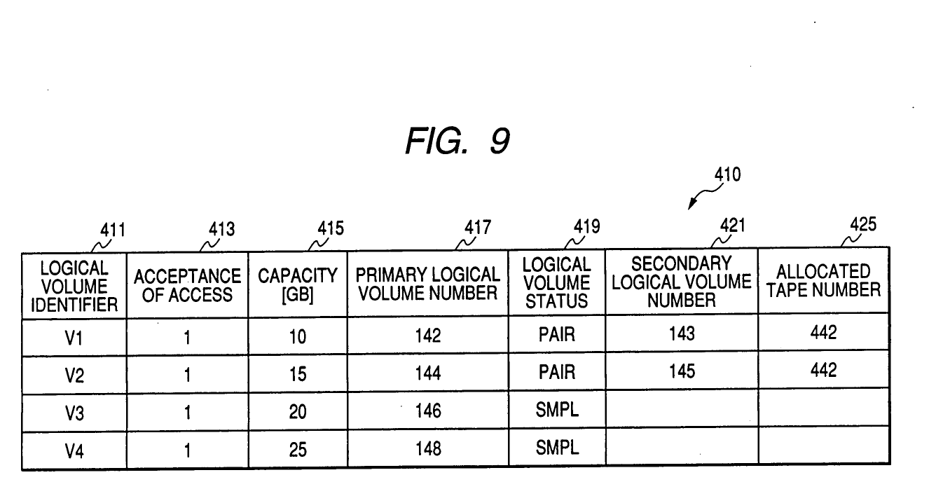

FIG. 9 shows the volume management information 410 when the process flow is completed. The LOGICAL VOLUME STATUSES 419 of the logical volumes 140 having the LOGICAL VOLUME IDENTIFIERS 411 of V1 and V2 are set to PAIR 24, and values are set to the SECONDARY LOGICAL VOLUME NUMBERS 421 and the ALLOCATED TAPE NUMBERS 425, respectively.

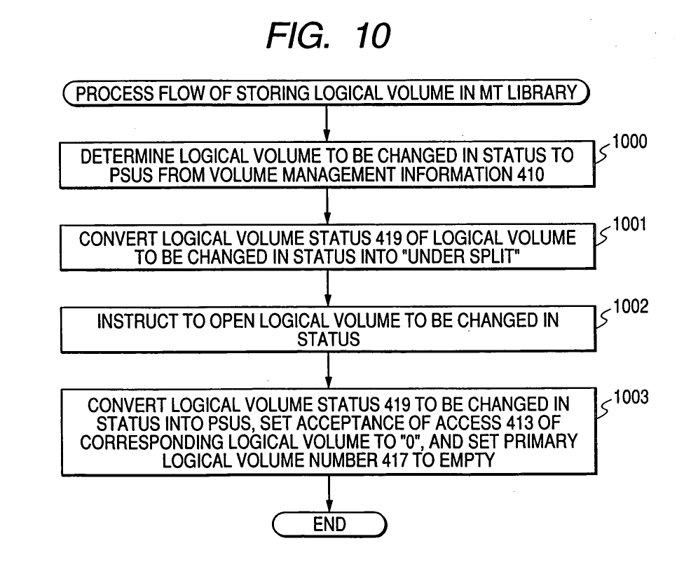

FIG. 10 is a process flow diagram illustrating the status change from PAIR 24 to PSUS 26, as shown in FIG. 5A. Here, the logical volumes 140 having the LOGICAL VOLUME IDENTIFIERS 411 of V1 and V2 are changed in status.

At step 1000, the logical volumes 140 to be changed in status to PSUS 26 are specified. The logical volumes 140 to be changed in status may be specified directly by the host system 300 or the management server 600, or they may be determined by the processor 110 using any method. Here, the logical volumes 140 having the LOGICAL VOLUME IDENTIFIERS 411 of V1 and V2 are specified.

At step 1001, the LOGICAL VOLUME STATUSES 419 of the logical volumes 140 to be changed in status are converted to UNDER SPLIT 25. Here, the LOGICAL VOLUME STATUSES 419 having the LOGICAL VOLUME IDENTIFIERS 411 of V1 and V2 are changed to UNDER SPLIT 25.

At step 1002, the area of the disk device 150 to which the logical volumes 140 to be changed in status are allocated is opened. Here, the area of the disk device 150 to which the logical volumes 140 having the LOGICAL VOLUME IDENTIFIERS 411 of V1 and V2 are allocated is opened.

Finally, at step 1003, the LOGICAL VOLUME STATUSES 419 of the logical volumes 140 to be changed in status are converted to PSUS 26. The PRIMARY LOGICAL VOLUME NUMBERS 417 of the corresponding logical volumes 140 are set to null. Here, the LOGICAL VOLUME STATUSES 419 having the LOGICAL VOLUME IDENTIFIERS 411 of V1 and V2 are changed to PSUS 26 and the PRIMARY LOGICAL VOLUME NUMBERS 417 are set to null.

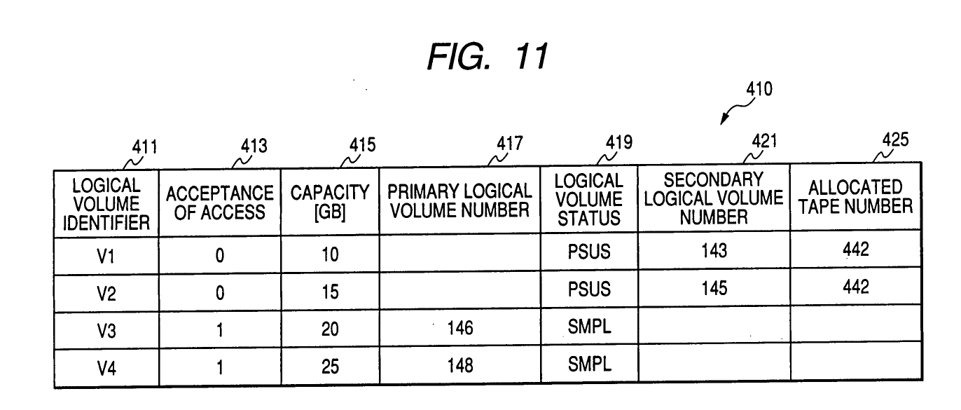

FIG. 11 shows the volume management information 410 when the process flow is completed. The LOGICAL VOLUME STATUSES 419 of the logical volumes 140 having the LOGICAL VOLUME IDENTIFIERS 411 of V1 and V2 are set to PSUS 26 and the PRIMARY LOGICAL VOLUME NUMBERS 417 thereof are set to null.

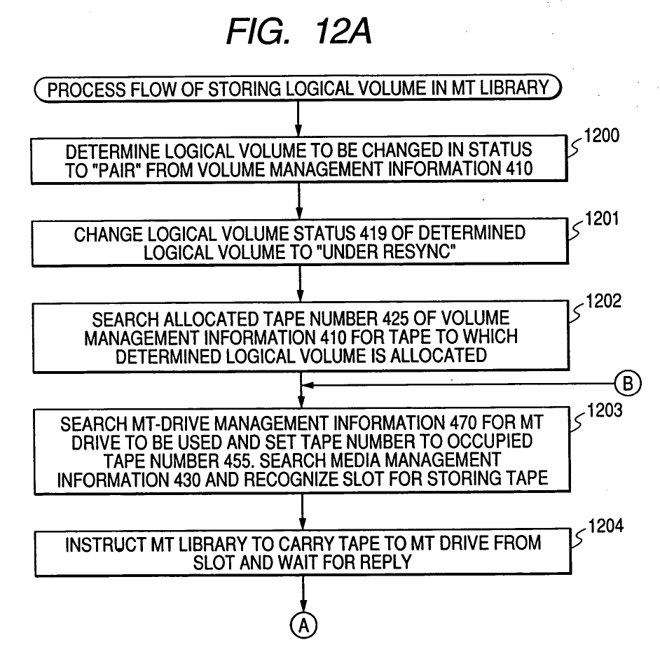

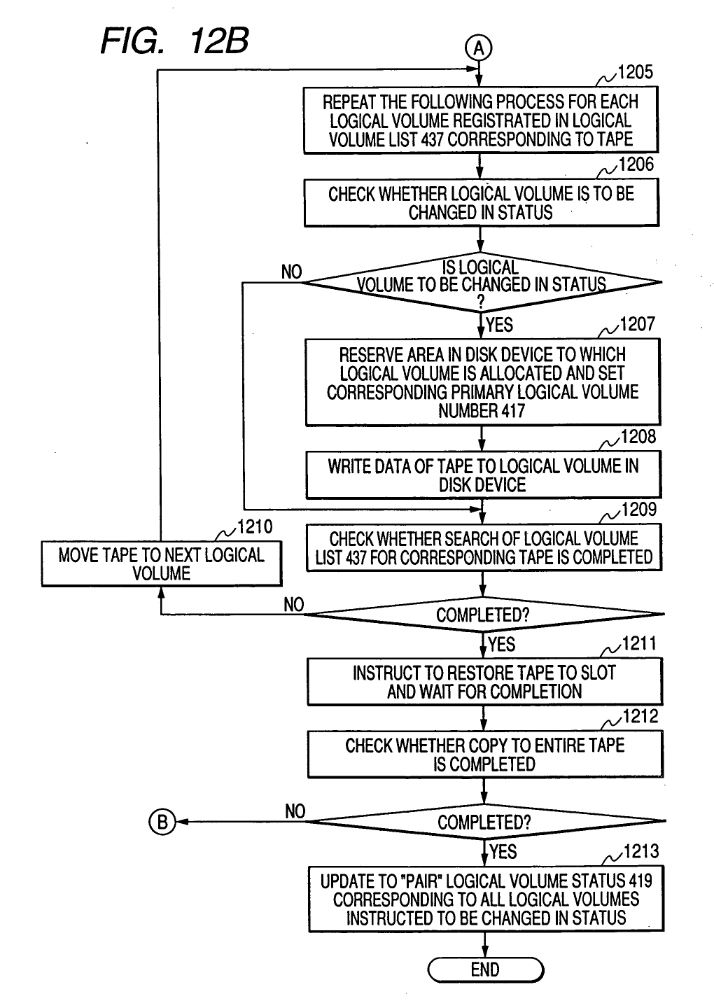

FIGS. 12A and 12B show process flows illustrating the status change from PSUS 26 to PAIR 24, as shown in FIG. 5A. Here, it is assumed that the logical volumes 140 having the LOGICAL VOLUME IDENTIFIERS 411 of V1 and V2 are changed in status.

At step 1200, the logical volumes 140 to be changed in status to PAIR 24 are specified. The logical volumes 140 to be changed in status may be specified directly by the host system 300 or the management server 600, or it may be determined by the processor 110 using any method. Here, the logical volumes 140 having the LOGICAL VOLUME IDENTIFIERS 411 of V1 and V2 are specified.

At step 1201, the LOGICAL VOLUME STATUSES 419 of the specified logical volumes 140 are changed to UNDER RESYNC 27.

At step 1202, the tape 10 allocated to the SECONDARY LOGICAL VOLUME NUMBERS 421 of the logical volumes 140, that is, the ALLOCATED TAPE NUMBER 425 is searched out from the volume management information 410. Here, 442 which is a content of the ALLOCATED TAPE NUMBER 425 having the LOGICAL VOLUME IDENTIFIERS 411 of V1 and V2 is the TAPE NUMBER 435 of the desired tape 10.

At step 1203, one is selected from the tapes 10 searched out at step 1202, and the MT drive 540 used for restoring data to the disk device 150 is determined. The MT drive 540 to be used can be determined by searching the MT-drive management information 450. Here, the TAPE NUMBER 435 of the selected tape 10 is set to the OCCUPIED TAPE NUMBER 455 of the determined MT drive 540. The media management information 430 is searched for the slot 570 storing the tape 10.

At step 1204, the MT library 500 is instructed to carry the tape 10 selected at step 1203 to MT drive 540, and a reply is waited for.

Thereafter, at step 1205 (FIG. 12B), the subsequent step is repeatedly performed to each logical volume 140 registered in the LOGICAL VOLUME LIST 437 corresponding to the tape 10.

At step 1206, it is checked whether the registered logical volume 140 is to be changed in status or not. When it is to be changed in status, a processing continuing from step 1207 is performed, and when it is not to be changed in status, a processing continuing from step 1209 is performed.

At step 1207, an area of the disk device 150 to which the logical volume 140 should be allocated is reserved. The PRIMARY LOGICAL VOLUME NUMBER 417 corresponding to the logical volume 140 is set.

At step 1208, data of the tape 10 is written to the logical volume 140 of the disk device 150.

At step 1209, it is checked whether the search of the LOGICAL VOLUME LIST 437 of the corresponding tape 10 is completed. When the search is completed, processing continuing from step 1211 is performed, and when the search is not completed, processing continuing from step 1210 is performed.

At step 1210, a process of transferring the tape 10 to the next logical volume 140 is preformed. Specifically, the MT drive 540 is instructed to transfer the tape up to a predetermined block, and data of the corresponding logical volume 140 may be transferred to the disk system 100 from the MT drive 540 and be discarded. After completion of step 1210, the processing beginning from step 1205 is performed again.

At step 1211, it is instructed to restore the tape 10 having been subjected to the process to the original slot 570 and the completion is waited for. Thereafter, at step 1212, it is checked whether the copy of all the tapes 10 specified at step 1202 is completed. When the copy is not completed, the processing beginning from step 1203 is performed again.

When the copy is completed, at step 1213, the statuses of the LOGICAL VOLUME STATUSES 419 corresponding to all of the logical volumes 140 specified to be changed in status at step 1200 are set to PAIR 24. Here, the statuses of the LOGICAL VOLUME STATUSES 419 having the LOGICAL VOLUME IDENTIFIERS 411 of V1 and V2 are set to PAIR 24.

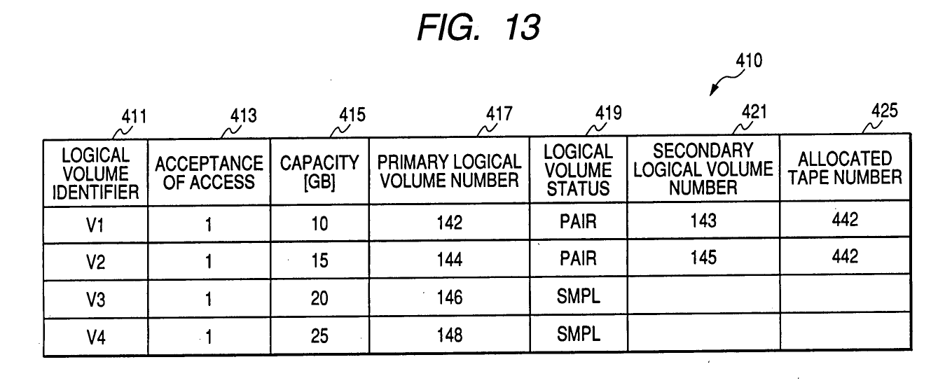

FIG. 13 shows the volume management information 410 when the process flow is completed. The LOGICAL VOLUME STATUSES 419 of the logical volumes 140 having the LOGICAL VOLUME IDENTIFIERS 411 of V1 and V2 are set to PAIR 24, and values are set to the PRIMARY LOGICAL VOLUME NUMBERS 417.

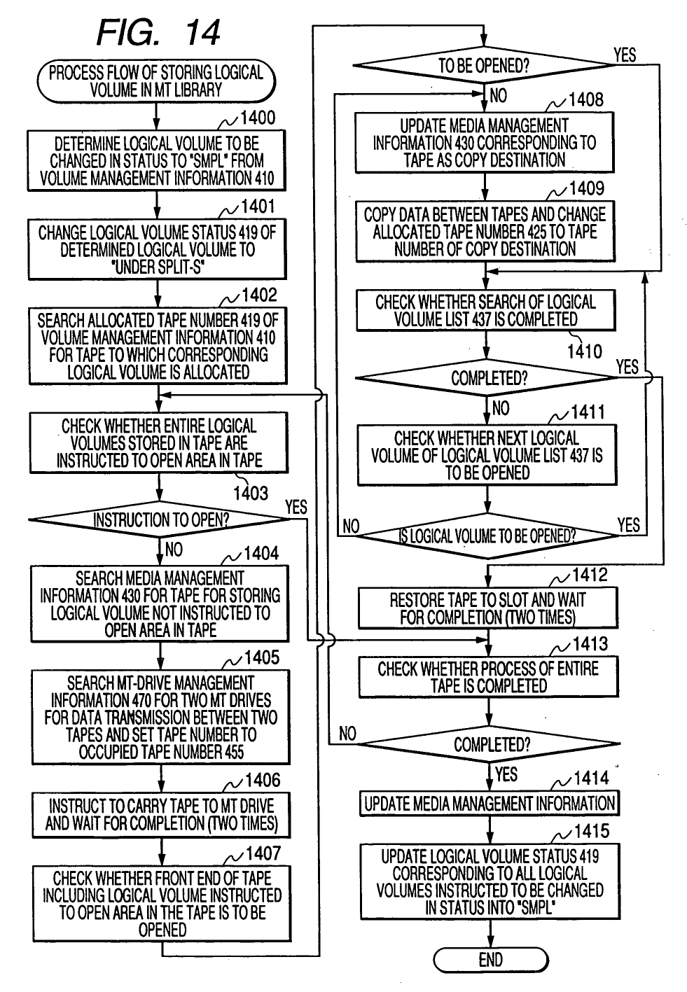

FIG. 14 is an example of the process flow illustrating the status change from the PAIR 24 to SMPL 22, as shown in FIG. 5A. Here, it is assumed that the logical volumes 140 having the LOGICAL VOLUME IDENTIFIERS 411 of V1 and V2 are changed in status.

At step 1400, the logical volumes 140 to be changed in status to SMPL 22 are specified. The logical volumes 140 to be changed in status may be specified directly by the host system 300 or the management server 600, or they may be determined by the processor 110 using any method. Here, it is assumed that the logical volumes 140 having the LOGICAL VOLUME IDENTIFIERS 411 of V1 and V2 are specified.

At step 1401, the LOGICAL VOLUME STATUSES 419 of the specified logical volumes 140 are changed to UNDER SPLIT-S 23.

At step 1402, the tape 10 allocated to the SECONDARY LOGICAL VOLUME NUMBERS 421 of the logical volumes 140, that is, the ALLOCATED TAPE NUMBER 425, is searched out from the volume management information 410. Here, 442, which is a content of the ALLOCATED TAPE NUMBER 425 having the LOGICAL VOLUME IDENTIFIERS 411 of V1 and V2, is the TAPE NUMBER 435 of the desired tape 10.

At step 1403, one is selected from the tapes 10 searched out at step 1402, and it is checked whether all of the logical volumes 140 stored in the tape 10 are instructed to open the areas of the tape 10. If so, processing continuing from step 1413 is performed. In this example, since all of the logical volumes 140 (corresponding to V1 and V2) included in the tape 10, of which the TAPE NUMBER 425 is 442, are to be opened, processing continuing from step 1413 is performed.

If not, the tape 10 for storing the logical volume 140 not instructed to open the corresponding area is determined at step 1404. Since it is not possible to partially delete the tape 10, another tape 10 should be allocated and the contents of the logical volume 140 not instructed to open the corresponding area should be copied to the tape, in order to delete a part of the contents. Such a tape is determined by searching the media management information 430 and finding out a tape 10 that is not being used.

At step 1405, two MT drives 540 for transmitting data between the tape 10 selected at step 1403 and the tape 10 selected at step 1404 are determined. The MT drives 540 to be used can be determined by searching the MT drive management information 450. Here, the TAPE NUMBER 435 of the selected tape 10 is set to the OCCUPIED TAPE NUMBER 455 of the determined MT drives 540. The slot 570 storing the tapes 10 is specified by searching the media management information 430.

At step 1406, the MT library 500 is instructed to carry the tape 10 determined at step 1405 to the MT drive 540 and a reply is waited for. Here, the instruction for carrying the tape is given two times for the completion.

Thereafter, at step 1407, on the basis of the information of the logical volume 140 registered at the front end of the LOGICAL VOLUME LIST 436 corresponding to the tape 10 including the logical volume 140 instructed to open the corresponding area, it is checked whether it is instructed to open the corresponding area. If so, the processing continuing from step 1410 is performed.

If not instructed to open the corresponding area, at step 1408, the following information is set to the media management information 430 corresponding to the tape 10 as a copy destination. First, the value of the CAPACITY 415 corresponding to the logical volume 140 is added to the TAPE CAPACITY UTILIZATION 434. Next, the NUMBER OF STORED LOGICAL VOLUMES 436 is increased by 1. The SECONDARY LOGICAL VOLUME NUMBER 421 corresponding to the logical volume 140 is added to the LOGICAL VOLUME LIST 347.

At step 1409, data of the tape 10 corresponding to the logical volume 140 is written to the tape 10 as a copy destination. After completion of the writing, the ALLOCATED TAPE NUMBER 425 corresponding to the logical volume 140 is changed to the TAPE NUMBER 435 corresponding to the tape 10 as the copy destination.

At step 1410, it is checked whether the search of the LOGICAL VOLUME LIST 437 of the tape 10 is completed. If so, processing continuing from step 1412 is performed. If not, it is checked at step 1411 whether the next logical volume 140 of the LOGICAL VOLUME LIST 437 is to be opened. If not, processing beginning from step 1408 is performed, and, if so, processing beginning from step 1410 is performed.

At step 1412, it is instructed to restore the processed tape 10 to the original slot 570 and the completion is waited for. This instruction is performed two times. At this time, before restoring the tape 10 including the logical volume 140 to be opened to the slot 570, all of the data of the tape 10 including the logical volume 140 to be opened may be deleted using any method, and then the carrying of the tape may be performed.

At step 1413, it is checked whether all of the tapes 10 specified at step 1402 have been processed. When the process is not completed, the processing continuing from step 1403 is performed again.

When the process is completed, at step 1414, the values of the media management information 430 corresponding to the tapes 10 specified at step 1402 are changed as follows. The TAPE CAPACITY UTILIZATION 434 is set to 0, the NUMBER OF STORED LOGICAL VOLUMES 436 is set to 0, and the LOGICAL VOLUME LIST 437 is set to null. Through step 1414, the tape not having deleted data at step 1412 is considered as having deleted data.

At step 1415, the LOGICAL VOLUME STATUSES 419 corresponding to all of the logical volumes 140 specified to be changed in status at 1400 are changed to SMPL 22. Here, the statuses of the LOGICAL VOLUME STATUSES 419 having the LOGICAL VOLUME IDENTIFIERS 411 of V1 and V2 are changed to SMPL 22.

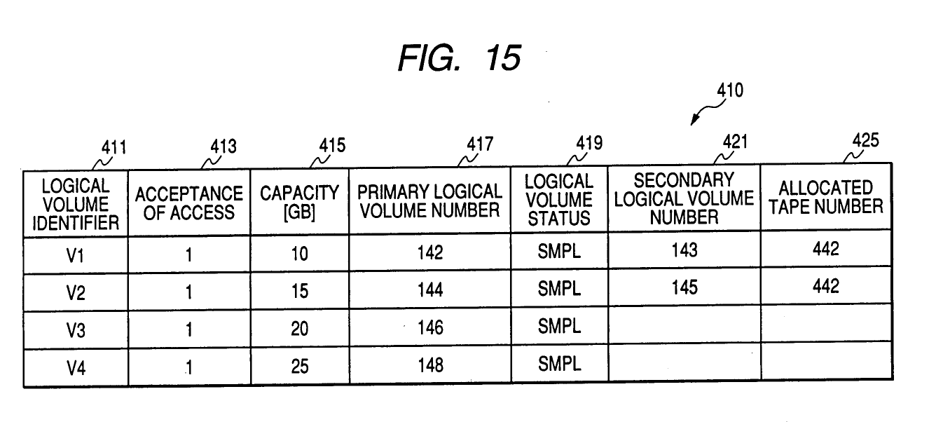

FIG. 15 shows the volume management information 410 when the process flow is completed. The LOGICAL VOLUME STATUSES 419 of the logical volumes 140 having the LOGICAL VOLUME IDENTIFIERS 411 of V1 and V2 are set to SMPL 22. In this example, since all of the logical volumes 140 (corresponding to V1 and V2) included in the tape 10 of which the ALLOCATED TAPE NUMBER 425 is 442 are to be opened and the copy of the logical volume 140 not to be opened is not necessary, the volume management information 430 is changed as described above. When the logical volume 140 is being copied, the ALLOCATED TAPE NUMBER 425 corresponding to the copied logical volume 140 is changed to the TAPE NUMBER 435 corresponding to the tape 10 as the copy destination.

Next, an example of the process flow corresponding to the status change of FIG. 5B will be described.

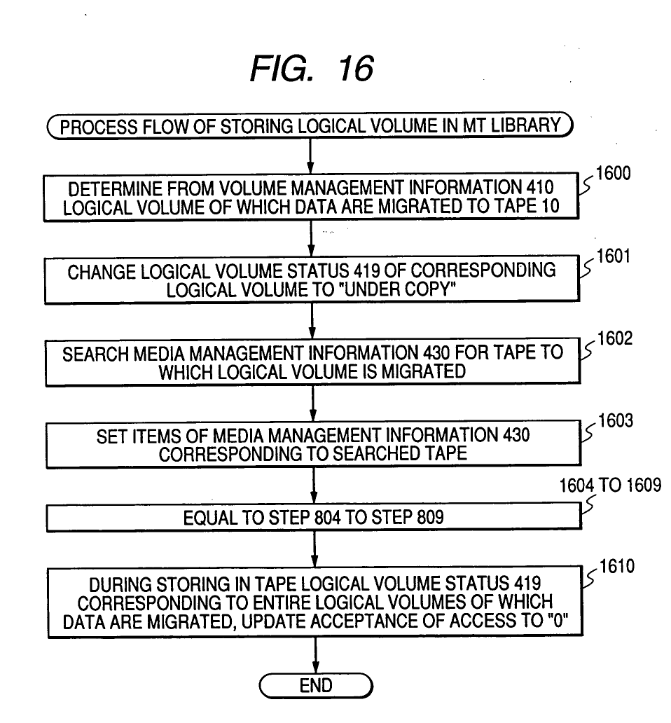

FIG. 16 is an example of the process flow illustrating the status change from SMPL 22 to UNDER STORE OF TAPE 37 shown in FIG. 5B. Here, it is assumed that the logical volumes 140 having the LOGICAL VOLUME IDENTIFIERS 411 of V1 and V2 are changed in status. It is also assumed that the tape 10 to which the logical volumes 140 should be allocated is the tape 10 of which the TAPE NUMBER 435 is 442.

At step 1600, the logical volumes 140 of which data should be transferred to the tape 10 are specified. The logical volumes 140 to be copied may be specified directly by the host system 300 or the management server 600, or it may be determined by the processor 110 using any method. Here, it is assumed that the logical volumes 140 having the LOGICAL VOLUME IDENTIFIERS 411 of V1 and V2 are specified.

At step 1601, the LOGICAL VOLUME STATUSES 419 of the corresponding logical volumes 140 are changed to UNDER COPY 36.

At step 1602, the tape 10 to which the logical volume 140 is transferred is determined. Such a tape is determined by searching the media management information 430 and finding a tape 10 that is not being used. Here, since the sum of the CAPACITIES 415 of the logical volumes 140 having the LOGICAL VOLUME IDENTIFIERS 411 of V1 and V2 is smaller than the TAPE CAPACITY 432 of the tape 10 having the TAPE NUMBER of 442, it is assumed that the tape 10 having the TAPE NUMBER 435 of 442 is set to the tape 10 to which the SECONDARY LOGICAL VOLUME NUMBER 421 should be allocated. Of course, when the sum of the CAPACITIES 415 of the logical volumes to be copied is greater, a plurality of tapes 10 are selected.

At step 1603, the sum value of the CAPACITIES 415 of the logical volumes 140 allocated to the selected tape 10 is written to the TAPE CAPACITY UTILIZATION 434 corresponding to the selected tape 10. The number of logical volumes 140 to be written to the tape 10 is set to the NUMBER OF STORED LOGICAL VOLUMES corresponding to the selected tape 10. Finally, a list of the PRIMARY LOGICAL VOLUME NUMBERS 419 corresponding to the logical volumes 140 to be written to the tape 10 is prepared and set to the LOGICAL VOLUMES 327 corresponding to the selected tape 10. Here, the sum value of the CAPACITIES 415 of the logical volumes 140 having the LOGICAL VOLUME IDENTIFIERS 411 of V1 and V2 is set to the tape CAPACITY, 2 is set to the NUMBER OF STORED LOGICAL VOLUMES 436, and the list of the PRIMARY LOGICAL VOLUME NUMBERS 417 having the LOGICAL VOLUME IDENTIFIERS 411 of V1 and V2 is set to the LOGICAL VOLUME LIST 437. Here, the logical volumes are stored in the order of V1 and V2.

Since the processes of step 1604 to step 1609 correspond to the processes of step 804 to step 809 on a one to one basis, description thereof will be omitted.

At step 1610, the statuses of the LOGICAL VOLUME STATUSES 419 corresponding to all of the logical volumes 140 specified to transfer data at step 1600 are set to UNDER STORE OF TAPE 37. Here, the statuses of the LOGICAL VOLUME STATUSES 419 having the LOGICAL VOLUME IDENTIFIERS 411 of V1 and V2 are set to UNDER STORE OF TAPE 37.

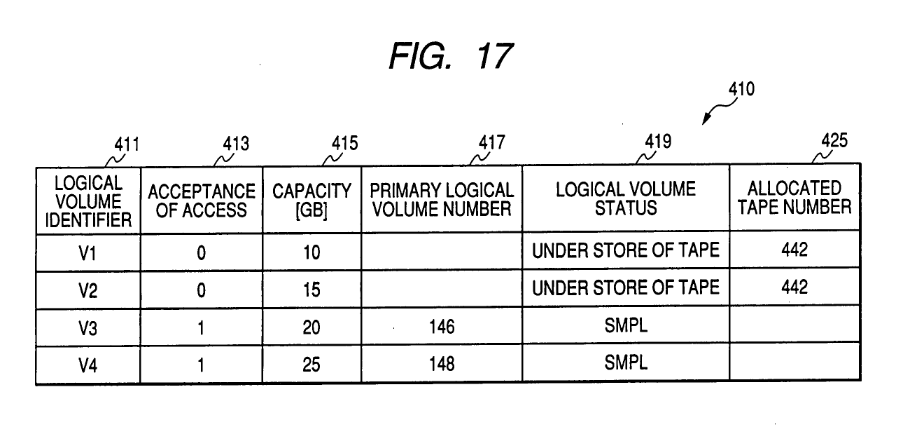

FIG. 17 shows the volume management information 410 when the process flow is completed. The LOGICAL VOLUME STATUSES 419 of the logical volumes 140 having the LOGICAL VOLUME IDENTIFIERS 411 of V1 and V2 are set to UNDER STORE OF TAPE 37 and values are set to the ALLOCATED TAPE NUMBERS 425.

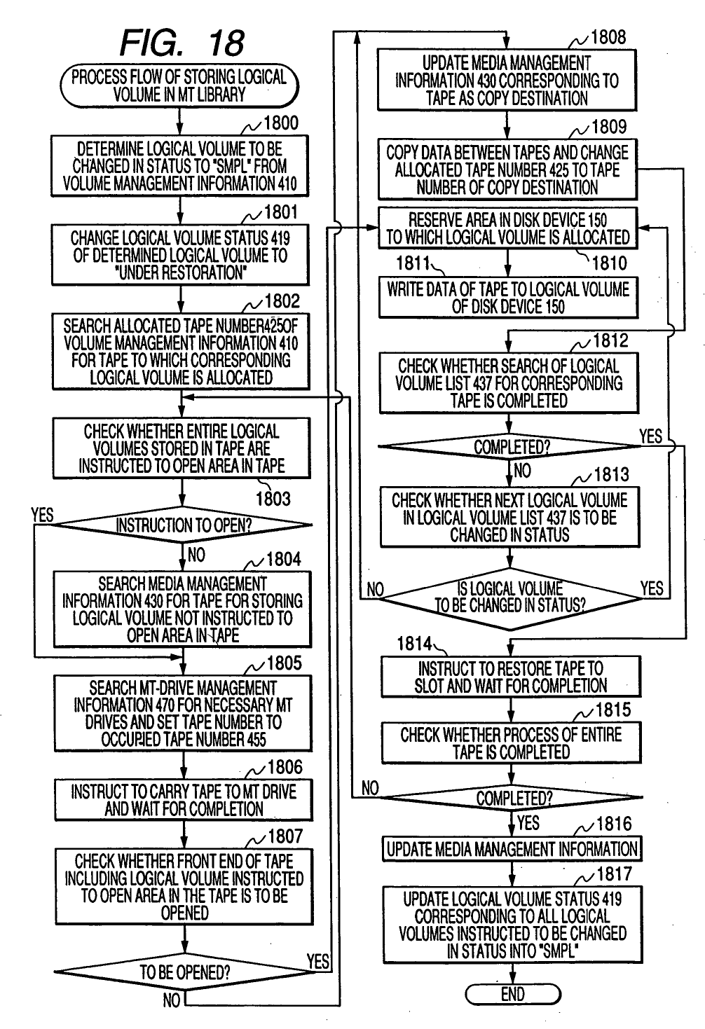

FIG. 18 is an example of the process flow illustrating the status change from the UNDER STORE OF TAPE 37 to SMPL 22, as shown in FIG. 5B. Here, it is assumed that the logical volumes 140 having the LOGICAL VOLUME IDENTIFIERS 411 of V1 and V2 are changed in status.

At step 1800, the logical volumes 140 to be changed in status to SMPL 22 are specified. The logical volumes 140 to be changed in status may be specified directly by the host system 300 or the management server 600, or they may be determined by the processor 110 using any method. Here, it is assumed that the logical volumes 140 having the LOGICAL VOLUME IDENTIFIERS 411 of V1 and V2 are specified.

At step 1801, the LOGICAL VOLUME STATUSES 419 of the specified logical volumes 140 are changed to UNDER RESTORATION 38.

At step 1802, the tapes 10 allocated to the SECONDARY LOGICAL VOLUME NUMBERS 421 of the logical volumes 140, that is, the ALLOCATED TAPE NUMBERS 425, are searched out from the volume management information 410. Here, it is assumed that 442, which is a content of the ALLOCATED TAPE NUMBER 425 having the LOGICAL VOLUME IDENTIFIERS 411 of V1 and V2, is the TAPE NUMBER 435 of the desired tape 10.

At step 1803, one is selected from the tapes 10 searched out at step 1802, and it is checked whether all of the logical volumes 140 stored in the tape 10 are instructed to open the corresponding areas in the tape 10. If so, processing continuing from step 1805 is performed. In this example, since all of the logical volumes 140 (corresponding to V1 and V2) included in the tape 10 of which the tape number 425 is 442 is to be opened, processing continuing from step 1805 is performed.

If not, the tape 10 for storing the logical volume 140 not instructed to open the corresponding area is determined at step 1804. Since it is not possible to partially delete the tape 10, another tape 10 should be allocated and the contents of the logical volume 140 not instructed to open the corresponding area should be copied to the tape 10, in order to delete a part of the contents. Such a tape is determined by searching the media management information 430 and finding out a tape 10 that is not being used.

At step 1805, the MT drive 540 to be used is selected. Specifically, the MT drive 540 to be used for the tape 10 selected at step 1803 is selected first of all. When a tape to be copied is selected as a result of step 1804, another MT drive 540 is selected. The MT drives 540 to be used can be determined by searching the MT-drive management information 450. Here, the TAPE NUMBER 435 of the selected tape 10 is set to the OCCUPIED TAPE NUMBER 455 of the determined MT drives 540. The slot 570 for storing the tapes 10 is specified by searching the media management information 430.

At step 1806, the MT library 500 is instructed to carry the tape 10 determined at step 1405 to the MT drive 540 and a reply is waited for. Here, when one MT drive 540 is selected at step 1805, the instruction for carrying the tape is given one time, and when two MT drives 540 are selected at step 1805, the instruction for carrying the tape is given two times, thereby completing the carrying of the tape.

Thereafter, at step 1807, on the basis of the information of the logical volume 140 registered at the front end of the LOGICAL VOLUME LIST 436 corresponding to the tape 10 including the logical volume 140 instructed to open the corresponding area, it is checked whether it is instructed to open the corresponding area. If so, processing continuing from step 1810 is performed.

If not instructed to open the corresponding area, at step 1808, the following information is set to the media management information 430 corresponding to the tape 10 as a copy destination. First, the value of the CAPACITY 415 corresponding to the logical volume 140 is added to the TAPE CAPACITY UTILIZATION 434. Next, the NUMBER OF STORED LOGICAL VOLUMES 436 is increased by 1. The SECONDARY LOGICAL VOLUME NUMBER 421 corresponding to the logical volume 140 is added to the LOGICAL VOLUME LIST 347.

At step 1809, data of the tape 10 corresponding to the logical volume 140 is written to the tape 10 as the copy destination. After completion of the writing, the ALLOCATED TAPE NUMBER 425 corresponding to the logical volume 140 is changed to the TAPE NUMBER 435 corresponding to the tape 10 as the copy destination. Thereafter, processing continuing from step 1812 is performed.

At step 1810, an area in the disk device 150 to which the logical volume 140 should be allocated is reserved.

At step 1811, the data of the tape 10 is written to the logical volume 140 in the allocated disk device 150.

At step 1812, it is checked whether the search of the LOGICAL VOLUME LIST 437 of the tape 10 is completed. If so, processing continuing from step 1814 is performed. If not, at step 1813, it is checked whether the next logical volume 140 in the LOGICAL VOLUME LIST 437 should be changed in status. If not, processing continuing from step 1808 is performed, and, if so, processing continuing from step 1810 is performed.

At step 1814, it is instructed to restore the processed tape 10 to the original slot 570 and the completion thereof is waited for. The instruction for restoring the tape is given one time when one MT drive 540 is selected at step 1805, and the instruction for restoring the tape is given two times when two MT drives 540 are selected at step 1805, thereby completing the carrying of the tape.

At step 1815, it is checked whether all of the tapes 10 specified at step 1802 have been processed. When all of the tapes have not been processed, the processing continuing from step 1803 is performed again.

When all of the tapes have been processed, at step 1816, the values of the media management information 430 corresponding to the tapes 10 specified at step 1802 are changed as follows. The TAPE CAPACITY UTILIZATION 434 is set to 0, the NUMBER OF STORED LOGICAL VOLUMES 436 is set to 0, and the LOGICAL VOLUME LIST 437 is set to null.

At step 1817, the statuses of the LOGICAL VOLUME STATUSES 419 of the all of the logical volumes 140 specified to be changed in status at step 1800 are changed to SMPL 22. Here, the statuses of the LOGICAL VOLUME STATUSES 419 having the LOGICAL VOLUME IDENTIFIERS 411 of V1 and V2 are changed to the SMPL 22.

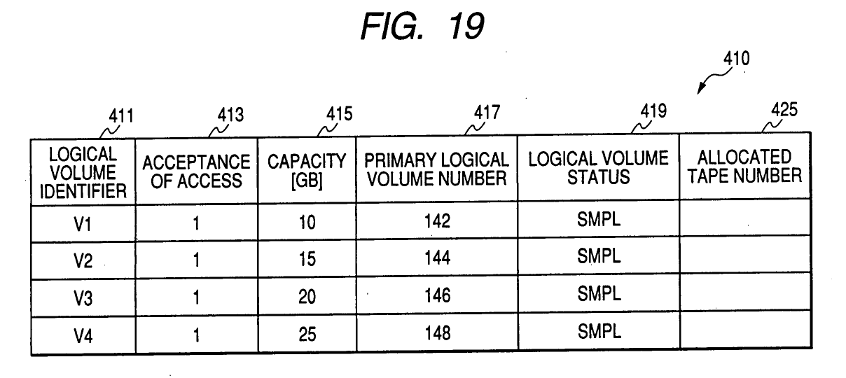

FIG. 19 shows the volume management information 410 when the process flow is completed. The LOGICAL VOLUME STATUSES 419 of the logical volumes 140 having the LOGICAL VOLUME IDENTIFIERS 411 of V1 and V2 are set to SMPL 22. In this example, since all of the logical volumes 140 (corresponding to V1 and V2) included in the tape 10 of which the TAPE NUMBER 425 is 442 are to be opened and the copy of the logical volume 140 not to be opened is not necessary, the volume management information 430 is changed as described above. When the logical volume 140 is being copied, the allocated TAPE NUMBER 425 corresponding to the copied logical volume 140 is changed to the TAPE NUMBER 435 corresponding to the tape 10 as the copy destination.

According to the aforementioned embodiment, the storage system can transfer data to the tape from the disk device with the lapse of time for preserving data, thereby performing a long-term preservation of the data, while taking the bit cost into account. Therefore, it is possible to provide a storage system which can store data on any one of a disk device and a tape in accordance with the utility value of data varying with time. For example, the storage system can perform long-term preservation of archive data not having frequent accesses using the tape, thereby not using the disk device which has a large bit cost. In addition, the storage system can restore data to the logical volume of the disk device from the logical volume of the tape in accordance with the variation in access frequency. In addition, it is possible to reduce the management cost of the storage system having different layers.

Even when data is transferred in the storage system, the host system can use the data as if the data exists in the disk device, without recognizing the transfer of data or the existence of the tape.

### Second Embodiment

A second embodiment of the present invention will be described with reference to the drawings.

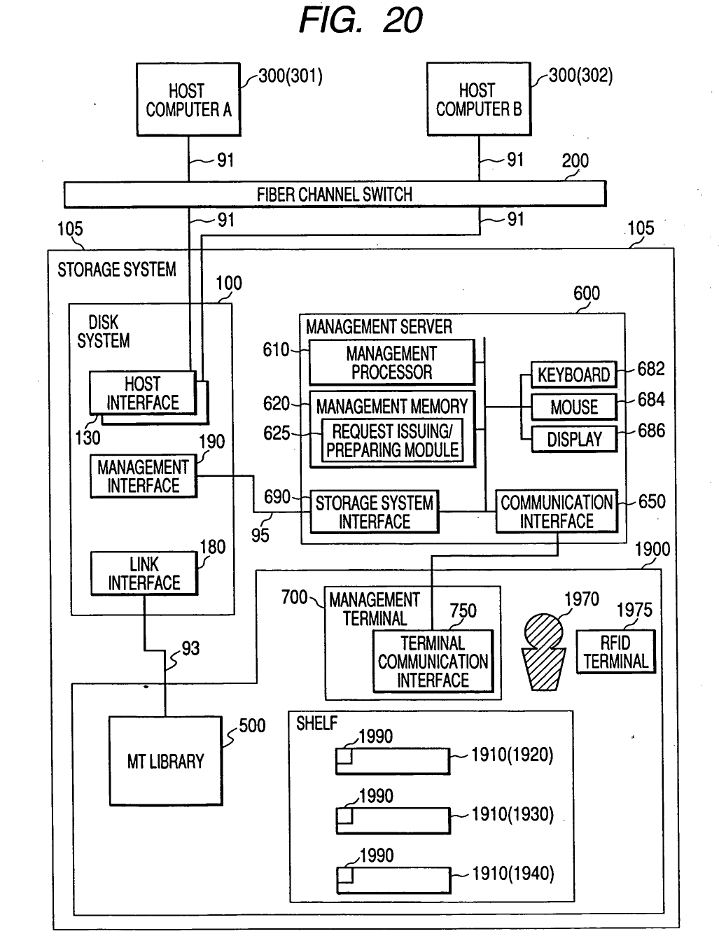

FIG. 20 is a structural block diagram illustrating a second embodiment of the present invention. The second embodiment is different from the first embodiment, in that one or more shelves 1910 for receiving the tape 10 are provided in addition to the MT library 500. As shown in FIG. 20, one or more shelves 1910 may be provided, with an example of shelves 1920, 1930 and 1940 being provided in FIG. 20. A maintenance man 1970 carries the tape 10 between the MT library 500 and a shelf 1910. Instruction to the maintenance man 1970 may be executed along a path of the disk system 100→the management server 600→a management terminal 700, or along a path of the management server 600→the management terminal 700. As a result, the management server 600 has a communication interface 650 which serves as an interface with the management terminal 700.

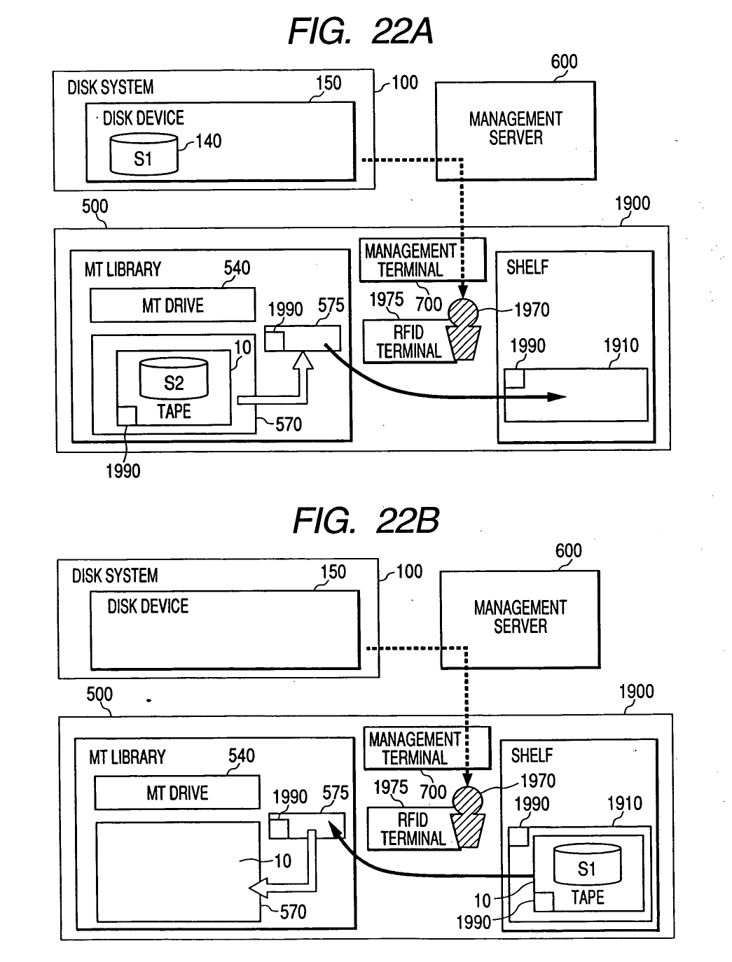

One or more maintenance men may exist. The maintenance man 1970 works with an RFID terminal 1975, so as to check whether a correct device is being treated. As a result, the respective shelves 1910 have an RFID 1990 and identifiers of the shelves 1910 are stored therein. The maintenance man 1970 can read out an RFID 1990 of a shelf 1910 and check whether a correct shelf 1910 is being manipulated, using the RFID terminal 1975. As shown in FIG. 22A, in the second embodiment, the tape 10 and the media injection and ejection port 575 of the MT library 500 may also have an RFID 1990, for the same purpose. The RFID 1990 of a tape 10 stores an identifier of the tape 10, and the RFID 1990 of the media injection and ejection port 575 stores identifiers of the corresponding MT library 500 and the corresponding media injection and ejection port 575.

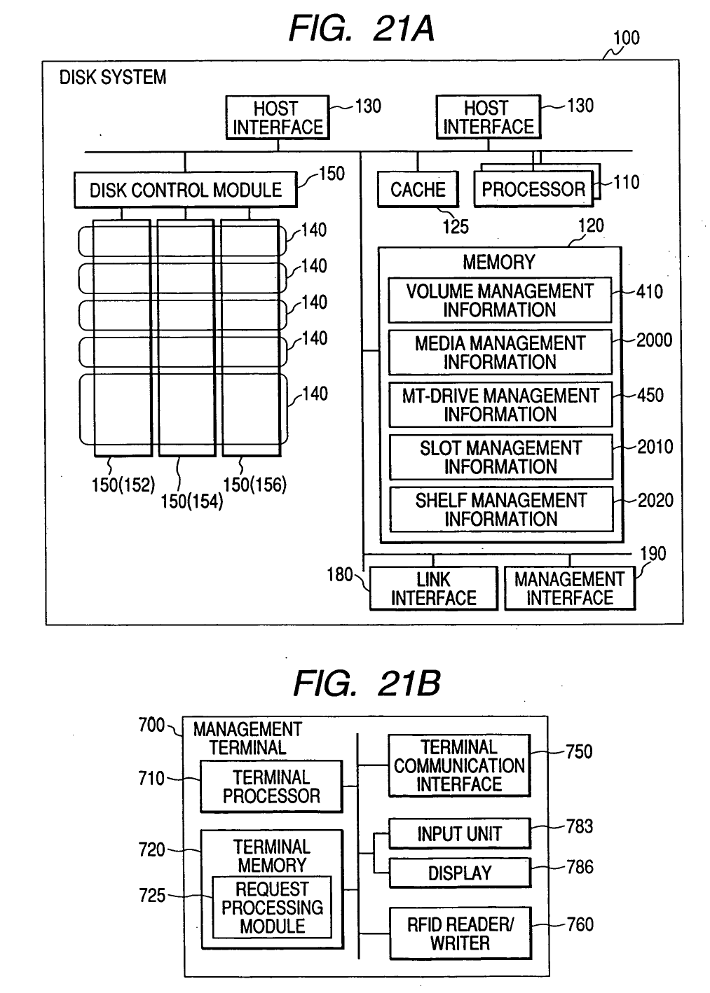

FIG. 21A is an example of the disk system 100, and FIG. 22B is an example of the management terminal 700 according to the second embodiment.

In the disk system 100, the information stored in the control memory 120 may be different from that of the first embodiment. Slot management information 2010 and shelf management information 2020 are newly added. Media management information 2000 has a format different from that of the first embodiment.

The management terminal 700 (FIG. 21B) may include a terminal processor 710, a terminal memory 720, a terminal communication interface 750, an RFID reader and writer 760, an input unit 783, and a display 786. The terminal memory 720 stores a request processing module 725.

The number of host computers 300 connected to the storage system 105 may be one or plural (for example, host computer A 301 and host computer B 302). The host computer 300 may include a CPU 310, a memory 320, and a disk interface 330.

The structure of the second embodiment is different from that of the first embodiment by the aforementioned description.

FIG. 22 integrally shows an example of the basic concepts of the second embodiment. The second embodiment is different from the first embodiment, in that the tape 10 storing contents of the logical volume 140 of the disk device 150 is taken out from the MT library 500 and received in the shelf 1910. The store of the tape 10 in the shelf 1910 can further reduce the cost, and thus can reduce the total cost of the storage system. The second embodiment may be characterized in that the logical volumes 140 of the tape 10 received in the shelf 1910 are recognized by the host computer 300, as if they exist in the disk system 100.

In the present embodiment, two examples of transfer methods are disclosed. FIG. 22A shows a transfer method corresponding to FIG. 4A in the first embodiment. The present embodiment is different from the first embodiment in that the tape 10 stored in the slot 570 is moved to the shelf 1910. When it is predicted that access is not made to the logical volume 140 stored in the tape 10 in the future, the tape 10 can be moved to the shelf 1910 from the slot 570. On the contrary, when it is necessary to restore the contents of the logical volume 140 stored in the tape 10 to the disk device 150, or when it is predicted that access can be made to the logical volume 140 stored in the tape 10 in the future, the tape 10 can be restored to the slot 570 from the shelf 1910.

FIG. 22B shows a transfer method corresponding to FIG. 4B in the first embodiment. The present embodiment is different from the first embodiment, in that the tape 10 stored in the slot 570 is moved to the shelf 1910, or the tape 10 is restored to the slot 570 from the shelf 1910. This difference is similar to the difference between FIG. 4A and FIG. 22A.

Now, an example of the contents of the media management information 2000, the slot management information 2010, and the shelf management information 2020 will be described.

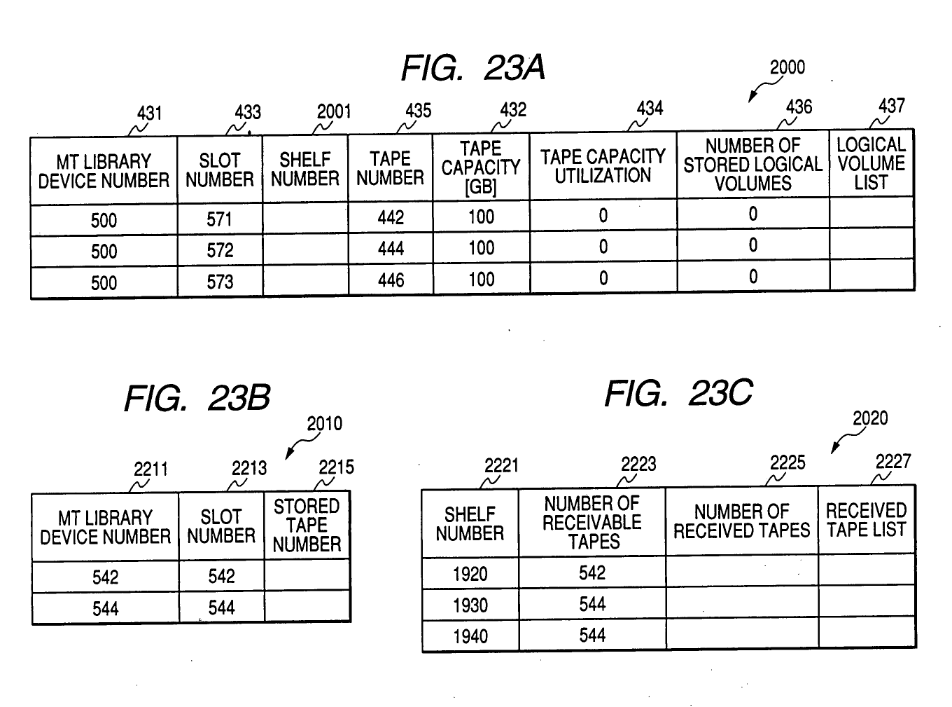

The media management information 2000 shown in FIG. 23A is information corresponding to the tape 10. In the second embodiment, since the tape 10 can exist in the shelf 1910, a SHELF NUMBER 2001 is newly provided. When the tape does not exist in the shelf 1910, this value is set to null. The MT LIBRARY DEVICE NUMBER 431 and the SLOT NUMBER 433 are similar to those of the first embodiment. On the other hand, in the first embodiment, since the tape 10 always exists in the MT library 500, the values are always effective. However, in the second embodiment, the tape 10 may not exist in the MT library 500. In this case, the values are set to null.

The slot management information 2010 shown in FIG. 23B is information corresponding to the slot 570. In the first embodiment, since it is assumed that the tape 10 is allocated to a specific slot 570, having only the management information on the tape 10 is sufficient. However, in the second embodiment, since the tape 10 can be moved between the slots and the shelves 1910, it is necessary to manage whether a slot is empty or is allocated to a tape 10. The necessary information includes a MT LIBRARY DEVICE NUMBER 2211, a SLOT NUMBER 2213, and a STORED TAPE NUMBER 2215. The MT LIBRARY DEVICE NUMBER 2211 is an identifier of the MT library 500 to which the corresponding slot 570 belongs, the SLOT NUMBER 2213 is an identifier of the corresponding slot, and the STORED TAPE NUMBER 2215 is an identifier of the tape 10 stored in the corresponding slot 570. The SLOT NUMBER is set to null when no tape 10 is stored in the corresponding slot.

The shelf information 2020 shown in FIG. 23C is information corresponding to the shelf 1910. The shelf information 2020 includes a SHELF NUMBER 2221, the NUMBER OF RECEIVABLE TAPES 2223, the NUMBER OF RECEIVED TAPES 2225, and a RECEIVED TAPE LIST 2227. The SHELF NUMBER 2221 is an identifier of the corresponding shelf 1910. The NUMBER OF RESPECTIVE TAPES 2223 denotes the number of tapes 10 which can be received in the corresponding shelf 1910. The NUMBER OF RECEIVED TAPES 2225 denotes the number of tapes 10 which are currently stored in the corresponding shelf. The RECEIVED TAPE LIST 2227 stores identifiers of all of the tapes 10 currently stored in the corresponding shelf. That is, the identifiers of the tapes 10 corresponding to the NUMBER OF RECEIVED TAPES 2225 are stored in the RECEIVED TAPE LIST 2227.

Now, an example of the process flow of the second embodiment will be described.

As described above, in the second embodiment, a process of moving the tape 10 between the slot 570 and the shelf 1910 is added to the processes of the first embodiment. Therefore, a process of moving the tape 10 to the shelf 1910 from the slot 570, and a process of moving the tape 10 to the slot 570 from the shelf 1910, are added thereto.

On the other hand, the example of process flows shown in FIGS. 8, 10, and 14 in connection the first embodiment can be applied to the second embodiment as they are. On the contrary, the process flows shown in FIGS. 12, 14, and 18 may not be able to be applied to the second embodiment as they are. This is because the tape 10 storing a logical volume 140 to be processed can exist in the shelf 1910 in the second embodiment. In this case, the tape 10 should be first moved to the slot 570 of the MT library 500 and then it should be processed.

The status changes shown in FIGS. 9, 11, 13, 15, 17, and 19 are true of the second embodiment as well.

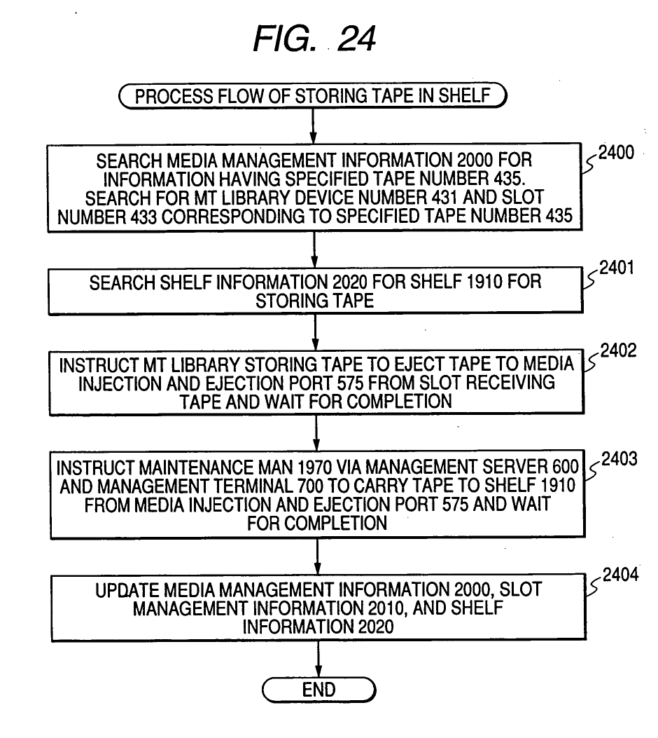

FIG. 24 is an example of the process flow executed by the processor 110 of the disk system 100 when a specific tape 10 is moved to the shelf 1910 from the slot 570. Here, the tape identifier of the tape 10 to be moved is an input value. The process flow may be performed in response to a request from the host computer 300 or the management server 600, or by means of determination of the disk system 100. For example, the process flow can be performed when the possibility that the host computer 300 accesses the logical volume 140 stored in the tape 10 is low for a while.

At step 2400, information having the same tape number 435 as the identifier of the specified tape 10 is found by searching the media management information 2000. The MT LIBRARY DEVICE NUMBER 431 and the SLOT NUMBER 433 corresponding to the TAPE NUMBER 435 are also recognized.

At step 2401, a shelf 1910 for receiving the tape 10 is determined. The shelf 1910 for receiving the tape is determined by searching the shelf information 2020, and finding a shelf 1910 having room for receiving the tape.

At step 2402, the MT library 500 storing the tape 10 is instructed to carry the tape 10 to the media injection and ejection port 575 from the slot 570 storing the tape and the completion thereof is waited for.

At step 2403, the management server 600 instructs the maintenance man 1970 via the management terminal 700 to carry the tape 10 to the shelf 1910 from the media injection and ejection port 575 of the MT library 500, and the completion thereof is waited for. At this time, the identifier of the MT library 500, the identifier of the media injection and ejection port 575, the identifier of the shelf 1910, and the identifier of the tape 10 are transmitted to the management terminal 700.

At step 2404, on the basis of the tape 10 carried to the shelf 1910, the information is changed. In the media management information 2000 corresponding to the tape, the identifier of the shelf 1910 newly storing the tape 10 is stored in the SHELF NUMBER 2001. On the other hand, the MT LIBRARY DEVICE NUMBER 431 and the SLOT NUMBER 433 are set to null. In the slot management information 2010, the TAPE NUMBER 2215 in the information on the corresponding slot 570 is set to null. In the shelf information 2020, the NUMBER OF STORED TAPES 2225 and the RECEIVED TAPE LIST 2227 in the information on the corresponding shelf 1910 are updated. Specifically, the NUMBER OF RECEIVED TAPES is increased by 1 and the identifier of the corresponding tape 10 is added to the RECEIVED TAPE LIST 2227.

The process flow is completed in this way.

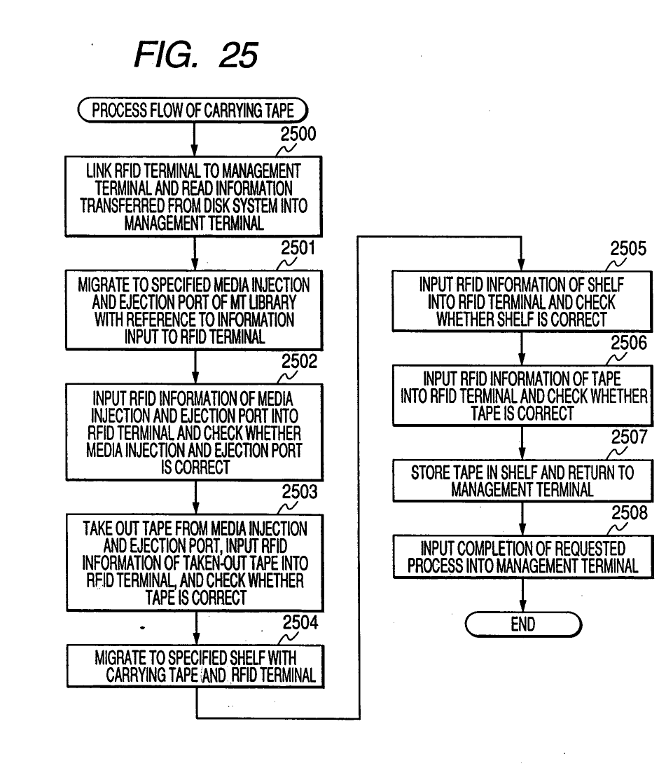

FIG. 25 shows an example of the process flow executed by the maintenance man 1970 when a specific tape 10 is moved to the shelf 1910 from the slot 570. The present process flow is a process of moving one tape 10, but a plurality of tapes 10 may be moved at a given time. The present process flow is carried out when the management terminal 700 is instructed to move the tape 10 to the shelf 1910.

At step 2500, the maintenance man 1970 connects the input unit 783 of the management terminal 700 to the RFID terminal 1975, and the management terminal 700 reads out the identifier of the MT library 500 received from the disk system 100, the identifier of the media injection and ejection port 575, the identifier of the shelf 1910, and the identifier of the tape 10. Erroneous operation can be prevented by directly inputting the identifiers to the RFID terminal 1975.

At step 2501, the maintenance man 1970 reaches the media injection and ejection port 575 of the specified MT library 500 with reference to the identifier of the MT library 500 input to the RFID terminal 1975 and the identifier of the media injection and ejection port 575. At this time, the maintenance man 1970 carries the RFID terminal 1975.

At step 2502, the maintenance man 1970 inputs the information of the RFID 1990 of the reached media injection and ejection port 575 to the RFID terminal 1975, and checks whether the input information corresponds to the identifier of the MT library 500 and the identifier of the media injection and ejection port 575 input at step 2500, thereby confirming whether the correct media injection and ejection port 575 being treated. Since treatment is performed using the RFID terminal 1975, erroneous treatment can be suppressed.

At step 2503, the maintenance man 1970 takes out the tape 10 carried to the media injection and ejection port 575 and inputs the information of the RFID 1990 of the tape 10 to the RFID terminal 1975. Then, the maintenance man checks whether the input information corresponds to the identifier of the tape 10 input at step 2500, thereby confirming whether the correct tape 10 is being treated. Since the treatment is performed using the RFID terminal 1975, erroneous treatment can be suppressed.

At step 2504, the maintenance man 1970 goes to the specified shelf 1910 with the tape 10 and the RFID terminal 1975 with reference to the identifier of the shelf 1910 input to the RFID terminal 1975.

At step 2505, the maintenance man 1970 inputs the information of the RFID 1990 of the reached shelf 1910 to the RFID terminal 1975 and checks whether the input information corresponds to the identifier of the shelf 1910 input at step 2500, thereby confirming whether the correct shelf 1910 is being treated. Since the treatment is performed using the RFID terminal 1975, erroneous treatment can be suppressed.

At step 2506, the maintenance man 1970 takes out the tape 10 carried by him and inputs the information of the RFID 1990 of the tape 10 to the RFID terminal 1975. The maintenance man checks whether the input information corresponds to the identifier of the tape 10 input at step 2500, thereby confirming whether the correct tape 10 is being treated. Since the treatment is performed using the RFID terminal 1975, erroneous treatment can be suppressed. In the present process flow, the maintenance man 1970 treats only one tape 10 and confirms that the correct tape 10 is being treated at step 2503, step 2506 can be considered unnecessary. However, when a plurality of tapes 10 are carried simultaneously and the tapes 10 are received in the shelf 1970, the confirmation may be important.

At step 2507, the maintenance man 1970 stores the confirmed tape 10 in the shelf 1910. Thereafter, the maintenance man 1970 goes back to the position of the management terminal 700.

At step 2508, the maintenance man 1970 inputs an indication of the completion of the requested process to the management terminal 700.

The management terminal 700 to which the indication of completion of the process is input reports the completion of the process to the disk system 100 via the management server 600.

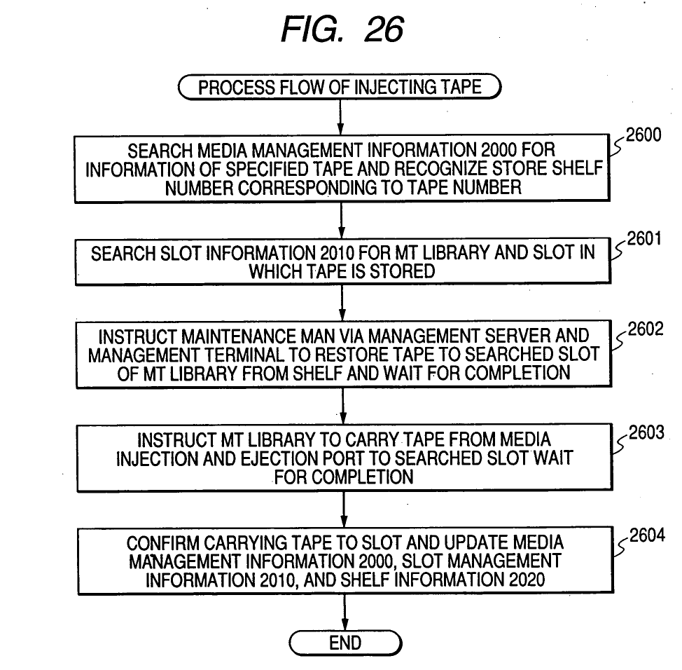

FIG. 26 shows an example of the process flow executed by the processor 110 of the disk system 100 when a specific tape 10 is moved to the slot 570 from the shelf 1910. Here, the identifier of the tape 10 to be moved is an input value. The process flow may be performed in response to the request from the host system 300 or the management server 600, or in accordance with determination of the disk system 100. For example, the process flow is performed when it is determined that the possibility that the host computer 300 accesses the logical volume 140 stored in the tape 10 is great.

At step 2600, the media management information 2000 is searched to find the information having the same tape number 435 as the identifier of the specified tape 10. The shelf number 2001 corresponding to the tape number 435 is recognized.

At step 2601, an MT library 500 and a slot 570 for storing the tape 10 are determined. By searching the slot information 2010 and finding a slot 570 that is not storing a tape 10, the slot 570 for storing the tape is determined.

At step 2602, the management server 600 instructs the maintenance man 1970 via the management terminal 700 to move the tape 10 to the media injection and ejection port 575 of the MT library 500 from the shelf 1910 receiving the tape 10, and waits for the completion thereof. At this time, the identifier of the MT library 500, the identifier of the media injection and ejection port 575, the identifier of the shelf 1910, and the identifier of the tape 10 are transmitted to the management terminal 700.

At step 2603, The MT library 500 storing the tape 10 is instructed to carry the tape 10 to the slot 570 determined at step 2601 from the media injection and ejection port 575, and the completion thereof is waited for.

At step 2604, on the basis of the tape 10 carried to the slot 570, the information is changed. In the media management information 2000 corresponding to the tape, the SHELF NUMBER 2001 is set to null. The identifiers of the MT library 500 and the slot 570 newly storing the tape 10 are set to the MT LIBRARY DEVICE NUMBER 431 and the SLOT NUMBER 433, respectively. In the slot management information 2010, the identifier of the tape 10 is set to the TAPE NUMBER 2215 in the information on the corresponding slot 570. In the shelf information 2020, the NUMBER OF STORED TAPES 2225 and the RECEIVED TAPE LIST 2227 in the information on the corresponding shelf 1910 are updated. Specifically, the NUMBER OF RECEIVED TAPES is decreased by 1 and the identifier of the corresponding tape 10 is deleted from the RECEIVED TAPE LIST 2227.

The process flow is completed in this way.

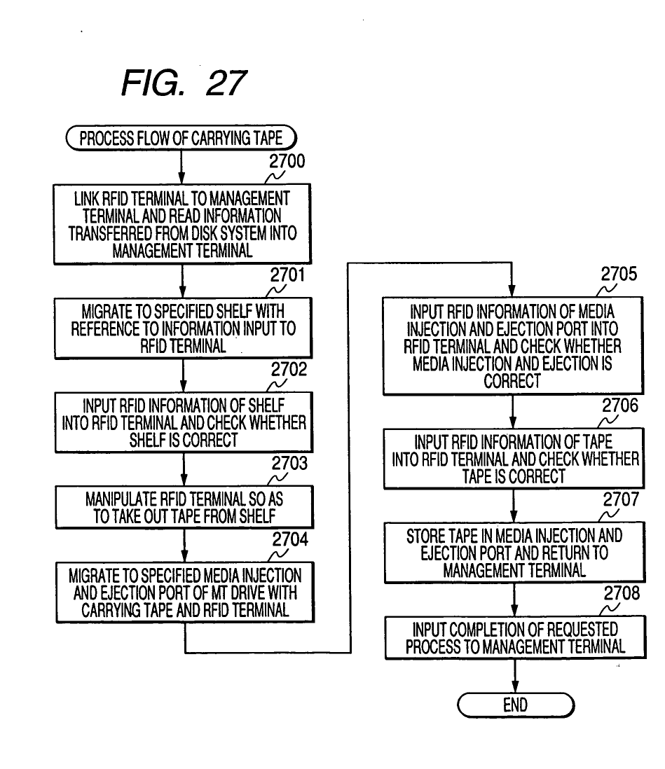

FIG. 27 shows an example of the process flow executed by the maintenance man 1970 when a specific tape 10 is moved to the slot 570 from the shelf 1910. The present process flow involves the moving of one tape 10, but a plurality of tapes 10 may be moved at a time. The present process flow is carried out when the management terminal 700 is instructed to move the tape 10 to the slot 570.

At step 2700, the maintenance man 1970 connects the input unit 783 of the management terminal 700 to the RFID terminal 1975, and the management terminal 700 reads out the identifier of the MT library 500 received from the disk system 100, the identifier of the media injection and ejection port 575, the identifier of the shelf 1910, and the identifier of the tape 10. Erroneous operation can be prevented by directly inputting the identifiers to the RFID terminal 1975.

At step 2701, the maintenance man 1970 reaches the specified shelf 1910 with reference to the identifier of the shelf 1910 input to the RFID terminal 1975. At this time, the maintenance man 1970 carries the RFID terminal 1975.

At step 2702, the maintenance man 1970 inputs the information of the RFID 1990 of the reached shelf 1910 to the RFID terminal 1975, and checks whether the input information corresponds to the identifier of the shelf 1910 input at step 2700, thereby confirming whether the correct shelf 1910 is being treated. Since the treatment is performed using the RFID terminal 1975, erroneous treatment can be suppressed.

At step 2703, the maintenance man 1970 manipulates the RFID terminal 1975, finds the tape 10 of which the RFID 1990 includes the identifier input at step 2700, and takes out the tape 10 from the shelf 1910. Since the treatment is performed using the RFID terminal 1975, erroneous treatment can be suppressed.

At step 2704, the maintenance man 1970 reaches the media injection and ejection port 575 of the specified MT library 500 with reference to the identifier of the MT library 500 input to the RFID terminal 1975 and the identifier of the media injection and ejection port 575, while carrying the tape 10 and the RFID terminal 1975.

At step 2705, the maintenance man 1970 inputs the information of the RFID 1990 of the reached media injection and ejection port 575 to the RFID terminal 1975, and checks whether the input information corresponds to the identifier of the MT library 500 and the identifier of the media injection and ejection port 575 input at step 2700, thereby confirming whether the correct media injection and ejection port 575 is being treated. Since the treatment is performed using the RFID terminal 1975, erroneous treatment can be suppressed.

At step 2706, the maintenance man 1970 takes out the tape 10 carried to the media injection and ejection port 575 and inputs the information of the RFID 1990 of the tape 10 to the RFID terminal 1975. The maintenance man checks whether the input information corresponds to the identifier of the tape 10 input at step 2701, thereby confirming whether the correct tape 10 is being treated. Since the treatment is performed using the RFID terminal 1975, erroneous treatment can be suppressed. In the present process flow, the maintenance man 1970 treats only one tape 10 and confirms that the correct tape 10 is being treated at step 2403, step 2406 may be considered as unnecessary. However, when a plurality of tapes 10 are carried simultaneously and the tapes 10 are stored in the media injection and ejection port 575, the confirmation may be important.

At step 2707, the maintenance man 1970 stores the confirmed tape 10 in the media injection and ejection port 575. Thereafter, the maintenance man 1970 goes back to the position of the management terminal 700.

At step 2708, the maintenance man 1970 inputs the completion of the requested process to the management terminal 700.

The management terminal 700 to which the completion of the process is input reports the completion of the process to the disk system 100 via the management server 600.

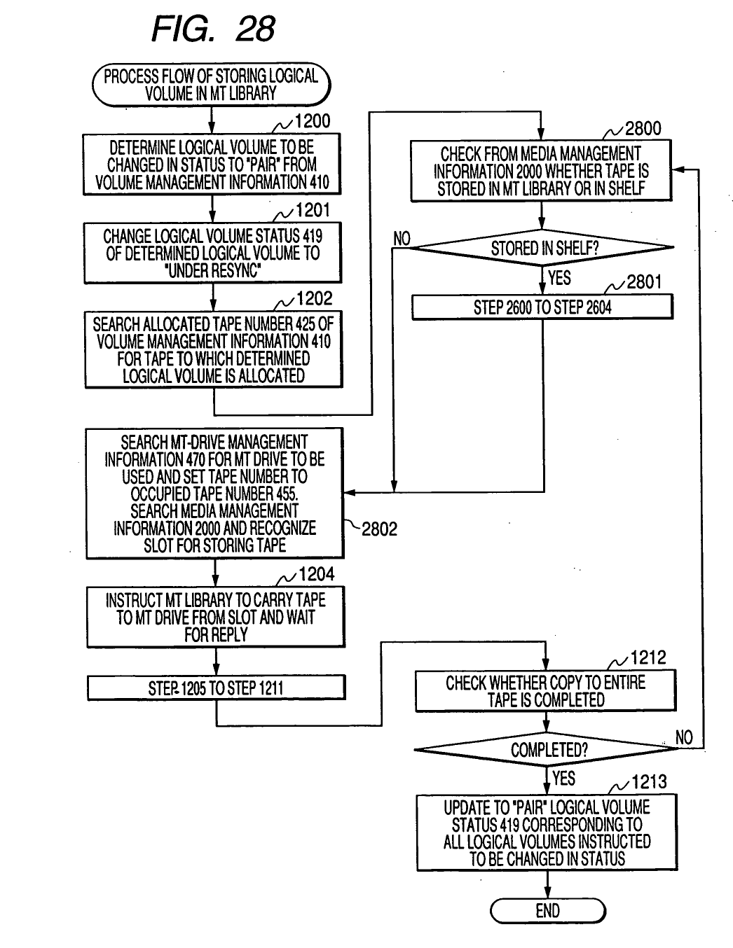

FIG. 28 shows an example of the process flow illustrating the status change to PAIR 24 from the PSUS 26 shown in FIG. 5A according to the second embodiment of the present invention. Here, only a part different from the process flow of FIG. 12 corresponding to the same status change as that of the first embodiment will be described.

At step 2800, one type is selected from the tapes 10 searched out at step 1202 and it is checked whether the tape 10 is stored in the MT library 500 or in the shelf 1910. This check is performed using the media management information 2000 corresponding to the tape 10. When the tape is stored in the MT library 500, processing continuing from step 2801 is performed, and, if not, processing continuing from step 2802 is performed.

At step 2801, the process flow shown in FIG. 26 is performed, thereby storing the tape 10 in the MT library 500.

At step 2802, the MT drive 540 to be used for restoring data to the disk device 150 is determined. The MT drive 540 to be used can be determined by searching the MT-drive management information 470. Here, the TAPE NUMBER 435 of the selected tape 10 is set to the OCCUPIED TAPE NUMBER 455 of the determined MT drive 540. Then, the media management information 2000 is searched, thereby recognizing the slot 570 storing the tape 10.

At step 1212, it is checked whether the copying of all of the tapes 10 specified at step 1202 is completed. When the copying is not completed, the processing continuing from step 2800 is performed again.

The other process flow of FIG. 28 is similar to the process flow of FIG. 12.

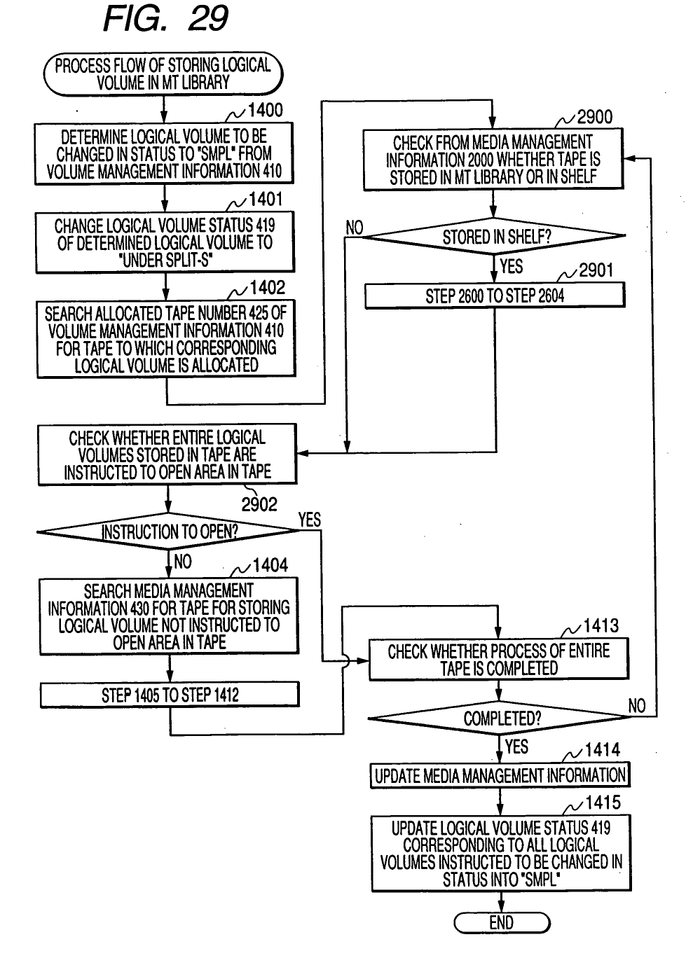

FIG. 29 shows an example of the process flow illustrating the status change to SMPL 22 from PAIR 24, as shown in FIG. 5A, according to the second embodiment. Here, only the part which is different from the process flow of FIG. 12 corresponding to the same status change as that of the first embodiment will be described.

At step 2900, one type is selected from the tapes 10 searched out at step 1402 and it is checked whether the tape 10 is stored in the MT library 500 or in the shelf 1910. This check is performed using the media management information 2000 corresponding to the tape 10. When the tape is stored in the MT library 500, processing continuing from step 2901 is performed, and, if it is not stored, continuing from step 2902 is performed.

At step 2901, the process flow shown in FIG. 26 is performed, thereby storing the tape 10 in the MT library 500.

At step 2902, it is checked whether all of the logical volumes 140 stored in the tape 10 are instructed to open the areas of the tape 10. If so, processing continuing from step 1413 is performed.

At step 1413, it is checked whether the copying of all of the tapes 10 specified at step 1402 is completed. When the copying is not completed, the processing continuing from step 2900 is performed again.

The other process flow of FIG. 29 is similar to the process flow of FIG. 18.

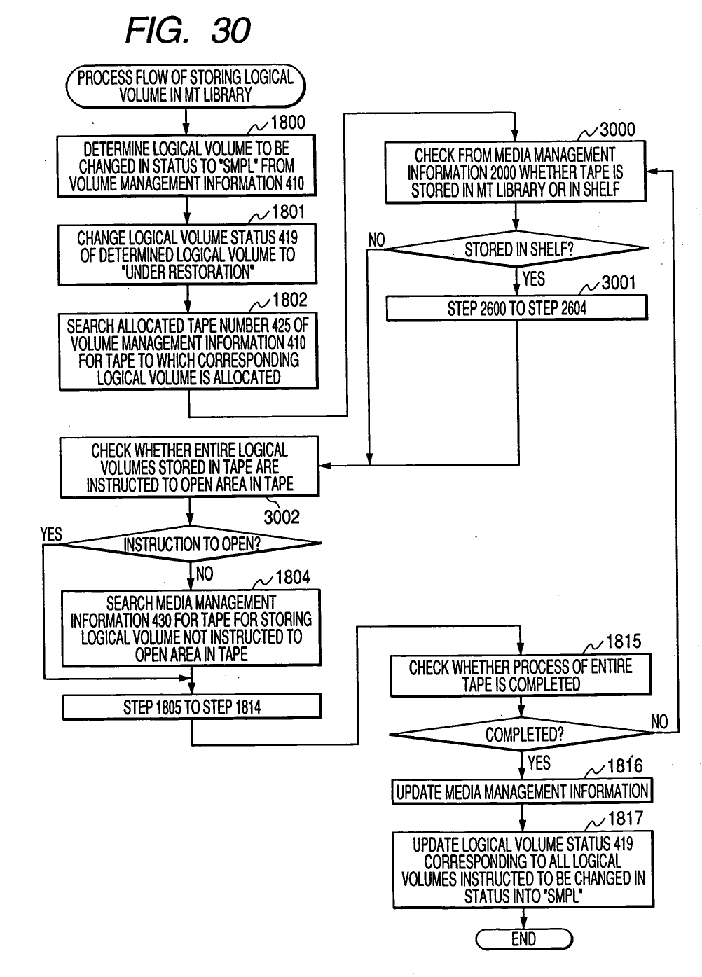

FIG. 30 shows an example of the process flow illustrating the status change to SMPL 22 from UNDER STORE OF TAPE 37, as shown in FIG. 5B, according to the second embodiment. Here, only the part which is different from the process flow of FIG. 12 corresponding to the same status change as that of the first embodiment will be described.

At step 3000, one type is selected from the tapes 10 searched out at step 1802 and it is checked whether the tape 10 is stored in the MT library 500 or in the shelf 1910. This check is performed using the media management information 2000 corresponding to the tape 10. When the tape is stored in the MT library 500, processing continuing from step 3001 is performed, and, when it is not stored, processing continuing from step 3002 is performed.

At step 3001, the process flow shown in FIG. 26 is performed, thereby storing the tape 10 in the MT library 500.

At step 3002, it is checked whether all the logical volumes 140 stored in the tape 10 are instructed to open the areas of the tape 10. If so, processing continuing from step 1805 is performed.

At step 1815, it is checked whether the copying of all of the tapes 10 specified at step 1802 is completed. When the copying is not completed, the processing continuing from step 3000 is performed again.

The other process flow of FIG. 30 is similar to the process flow of FIG. 18. In the embodiment described above, it is possible to reduce the management cost for a storage system having different layers, such as the disk device, the MT library, and a tape-storing warehouse.

To conclude, it is an object of the present invention to reduce the management cost by consolidating storage systems based on disk systems and portable storage devices such as an MT.

In order to achieve the aforementioned objects, according to a first aspect of the present invention, there is provided a first storage system in which a disk system and an MT library system are consolidated. The first storage system has a disk interface with respect to a host computer. Here, it should be noted that data stored in an MT was originally stored in the disk system. In a recent disk system having a RAID structure, it should be noted that a disk volume viewed from a user, that is, a host, does not correspond to a physical disk device on a one to one basis, but is a logical disk volume. Hereinafter, the disk volume may be referred to as a logical volume.

The first storage system may be characterized in that the logical volumes are stored in the MT. Information indicating in which MT a logical volume is stored, and in which slot of a library the MT is stored, is also held. Here, the slot means a space in the library storing a volume of the MT.

The first storage system also may be characterized in that areas of the disk system can be effectively used by storing a logical volume in an MT and then storing another logical volume in the area of the disk system having stored the logical volume. The MT storing contents of the logical volume is restored to a slot of the library. At this time, the first storage system memorizes which slot is allocated. However, the host computer recognizes the logical volume as if the logical volume stored in the MT exists in the disk system. As a result, when an access request to the logical volume stored in the MT is given from the host computer, the first storage system reserves a new area in the disk system, checks in which slot of the library the requested MT is stored, and transmits the MT to an MT drive from the slot. Thereafter, the first storage system copies data of the MT to the area and then accepts the access request from the host computer.

According to a second aspect of the present invention, there may be provided a second storage system for totally managing a disk system, an MT library system, an automatic changer, and a warehouse receiving MT. The second storage system has a disk interface with respect to a host computer. In the second storage system, the warehouse receiving the MT, the MT library system, and the automatic changer are placed close to one another. The disk system and the MT library or the automatic changer are connected to each other through a data transmission line, but the distance therebetween may be great. The second storage system is different from the first storage system in that the second storage system can manage an MT which is detached from the MT library or the automatic changer, which is received in the warehouse, and which cannot thus be automatically treated, that is, an MT requiring manual manipulation. Generally, when the MT is stored under a condition where it can be treated using an appliance, such as an MT library, library equipment corresponding to the number of MT volumes is necessary, thereby increasing the management cost.

Therefore, in order to reduce the management cost, users may detach the MT from the library or the automatic changer and may receive the MT separately. The second storage system can manage the MT under such a condition, thereby providing the users with convenient access. As a result, the second storage system has information indicating in which MT the respective logical volumes are stored and information indicating at which position of the warehouse the MT is placed.

An RFID (Radio Frequency Identification) tag for storing an identifier of each MT is attached to each MT. As a result, it is possible to recognize the MT by easily writing an identifier or reading out an identifier using a reader and a writer. Accordingly, when the MT having stored contents of the logical volume is detached from the MT library or the automatic changer and is received in the warehouse by a maintenance man, the second storage system receives and memorizes information indicating at which position of the warehouse the MT is received from the maintenance man.

When an access to the logical volume stored in the MT received in the warehouse is requested by the host computer, information indicating which MT is requested and information indicating at which position the MT is placed are communicated to the maintenance man of the warehouse. The maintenance man goes to the notified position, checks whether the MT is correct using a reader, fits the MT to the library or the automatic changer, and then communicates this fact to the second storage system. The second storage system reserves a new area in the disk system, transmits the MT in the library or the automatic changer to an MT drive, copies data of the MT to the area, and then accepts the access request from the host computer.

According to the embodiments of the present invention, data stored in a portable medium, such as a tape, can be managed integrally as data of a disk volume, thereby reducing the total maintenance cost for data in a computer system, including the bit cost for maintenance of data and the management cost for data.

Further, at least a portion (if not all) of the present invention may be practiced as a software invention, implemented in the form of one or more machine-readable medium having stored thereon at least one sequence of instructions that, when executed, causes a machine to effect operations with respect to the invention. With respect to the term “machine”, such term should be construed broadly as encompassing all types of machines, e.g., a non-exhaustive listing including: computing machines, non-computing machines, communication machines, etc. With regard to the term “one or more machine-readable medium”, the sequence of instructions may be embodied on and provided from a single medium, or alternatively, differing ones or portions of the instructions may be embodied on and provided from differing and/or distributed mediums. A “machine-readable medium” includes any mechanism that provides (i.e., stores and/or transmits) information in a form readable by a machine (e.g., a processor, computer, electronic device). Such a “machine-readable medium” term should be broadly interpreted as encompassing a broad spectrum of mediums, e.g., a non-exhaustive listing including: electronic medium (read-only memories (ROM), random access memories (RAM), flash cards); magnetic medium (floppy disks, hard disks, magnetic tape, etc.); optical medium (CD-ROMs, DVD-ROMs, etc); electrical, optical, acoustical or other form of propagated signals (e.g., carrier waves, infrared signals, digital signals); etc.

Method embodiments may be emulated as apparatus embodiments (e.g., as a physical apparatus constructed in a manner effecting the method); and, apparatus embodiments may be emulated as method embodiments.

Any reference in the specification to “one embodiment”, “an embodiment”, “example of an embodiment”, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment or component, it is submitted that it is within the purview of one skilled in the art to effect such feature, structure, or characteristic in connection with other ones of the embodiments and/or components. Furthermore, for ease of understanding, certain method procedures may have been delineated as separate procedures; however, these separately delineated procedures should not be construed as necessarily order dependent in their performance, i.e., some procedures may be able to be performed in an alternative order, simultaneously, etc.

This concludes the description of the embodiments. Although the present invention has been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combinations within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A storage system comprising:
a storage apparatus connectable to an electronic device, the storage apparatus including a controller, a memory and a plurality of disk devices; and
a library device connected to the storage apparatus, the library device including a plurality of slots to store a plurality of portable storage devices, a plurality of drives to read/write from/to the portable storage devices and a load/unload unit to move ones of the plurality of portable storage devices between the slots and the drives;
wherein the controller of the storage apparatus manages storage area according to a plurality of logical storage units, with a portion of the plurality of logical storage units being assigned to storage area of some of the plurality of portable storage devices.

2. A storage system according to claim 1, wherein the plurality of logical storage units include a first logical storage unit which is assigned to storage area of some of the plurality of disk devices and a second logical storage unit which is assigned to the storage area of some of the plurality of portable storage devices,
wherein the controller copies data stored in the storage area of some of the plurality of disk drives which has connection with the first logical storage unit, to the storage area of some of the plurality of portable storage devices which has connection with the second logical storage unit.

3. A storage system according to claim 2, wherein the controller assigns a same identifier used by the electronic device to the first and second logical storage units.

4. A storage system according to claim 3, wherein the controller deletes the same identifier from the first logical storage unit when the controller finishes copying from the first logical storage unit to the second logical storage unit.

5. A storage system according to claim 4, wherein the load/unload unit transfers one of the plurality of portable storage devices which has connection with the second logical storage unit to/from ones of the plurality of drives.

6. A storage system according to claim 5, wherein the controller sends a request to the load/unload unit if the controller receives an I/O request from the electronic device, which requests to access data stored in the second logical storage unit;
wherein the load/unload unit transfers the one of the plurality of portable storage devices to one of the plurality of drives responsive to receiving the request from the controller;
wherein the controller reads the data from the one of the plurality of portable storage devices loaded in the one of the plurality of drives.

7. A storage system according to claim 6, wherein the plurality of logical storage units include a third logical storage unit which is assigned to a second storage area of some of the plurality of disk units, wherein the controller copies data stored in the one of the plurality of portable storage devices related to the second logical storage unit to the second storage area of some of the plurality of disk units related to the third logical storage unit, and assigns the same identifier to the third logical storage unit.

8. A storage system according to claim 7, wherein the controller deletes the same identifier from the second logical storage unit when the controller finishes copying data from the second logical storage unit to the third logical storage unit.

9. A storage system according to claim 8, wherein the one of the plurality of drives deletes data stored in the one of the plurality of portable storage devices related to the second logical storage unit after copying data from the second logical storage unit to the third logical storage unit.

10. A storage system according to claim 9, comprising a shelf storage area to afford long-term-storage to ones of the portable storage devices,
wherein the library device includes an injection and ejection unit to facilitate movement of ones of the portable storage devices between the library device and the shelf storage area,
wherein the controller requests the injection and ejection unit of the library device to move the one of the plurality of portable storage devices from the one of the slot toward storage within the shelf storage area,
wherein the storage apparatus maintains information which include location information where the one of the plurality of portable storage devices is kept in the shelf storage area.

11. A storage system according to claim 10,
wherein the storage apparatus sends storage instruction information which include the location information and an instruction to an input/output interface accessible by maintenance personnel of the shelf storage area, such storage instruction information designating where the one of the plurality of portable storage devices should be stored within the shelf storage area.

12. A storage system according to claim 11,
wherein the storage apparatus sends retrieval instruction information which includes the location information and an instruction to the input/output interface accessible by maintenance personnel of the shelf storage area, such retrieval instruction information designating a move of one of the plurality of portable storage devices from the shelf to the injection and ejection unit of the library device.

13. A storage system according to claim 12,
wherein each of the plurality of portable storage devices, the injection and ejection unit and shelf of the shelf storage area, include an information appliance which stores readable identifier information.

14. A storage system according to claim 13,
wherein at least one of the storage instruction information and the retrieval instruction information sent by the storage apparatus includes the identifier information which identifies at least one of the one of the plurality of portable storage devices, the injection and ejection unit and the shelf.

15. A storage system comprising:
a storage apparatus including a controller, a memory and a plurality of disk devices;
a library device connected to the storage apparatus, the library device including a plurality of slots to store a plurality of portable storage devices, a plurality of drives to read/write to/from the portable storage devices, and a load/unload unit to move ones of the portable storage devices between the slots and the drives; and
a shelf storage area to afford long-term-storage to ones of the portable storage devices,
wherein the library device further includes injection and ejection unit to facilitate movement of ones of the portable storage devices between the library device and the shelf storage area,
wherein the controller requests the injection and ejection unit of the library device to move the one of the plurality of portable storage devices from one of the slots toward storage within the shelf storage area,
wherein the storage apparatus maintains information which include location information where the one of the plurality of portable storage devices is kept in the shelf storage area.

16. A storage system according to claim 15,
wherein the storage apparatus sends storage instruction information which include the location information and an instruction to an input/output interface accessible by maintenance personnel of the shelf storage area, such storage instruction information designating where the one of the plurality of portable storage devices should be stored within the shelf storage area.

17. A storage system according to claim 16,
wherein the storage apparatus sends retrieval instruction information which includes the location information and an instruction to the input/output interface accessible by maintenance personnel of the shelf storage area, such retrieval instruction information designating a move of one of the plurality of portable storage devices from the shelf to the injection and ejection unit of the library device.

18. A storage system comprising:
a storage apparatus including a controller, a memory and a plurality of disk devices;
a library device connected to the storage apparatus, the library device including a plurality of slots to store a plurality of portable storage devices, a plurality of drives to read/write to/from the portable storage devices, and a load/unload unit to move ones of the portable storage devices between-the slots and the drives; and
a shelf storage area to afford long-term-storage to ones of the portable storage devices,
wherein the library device further includes injection and ejection unit to facilitate movement of ones of the portable storage devices between the library device and the shelf storage area,
wherein each of the plurality of portable storage devices, the injection and ejection unit and shelf of the shelf storage area, include an information appliance which stores readable identifier information.

19. A storage system according to claim 18,
wherein instruction information sent by the storage apparatus regarding storage/retrieval includes the identifier information which identifies at least one of the one of the plurality of portable storage devices, the injection and ejection unit and a shelf of the shelf storage area, the identifier information regarding the shelf being useable by maintenance personnel of the shelf storage area regarding storage/retrieval with respect to the shelf storage area.
